(19) United States
(12) Patent Application Publication
(10) Pub. No.: US 2005/0209998 A1
(43) Pub. Date: Sep. 22, 2005

(54) Information management apparatus, information management system and storing medium storing information management software

(75) Inventors: Hidenori Takata, Kanagawa-ken (JP); Yoshiaki Kurasawa, Kanagawa-ken (JP); Kyoichi Hoshino, Chiba-ken (JP); Keiko Furuyama, Chiba-ken (JP); Toshihiko Wada, Kanagawa-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 11/126,175

(22) Filed: May 11, 2005

Related U.S. Application Data
(63) Continuation of application No. 09/852,615, filed on May 11, 2001, now abandoned.

(30) Foreign Application Priority Data
May 15, 2000 (JP) 141774/2000

(51) Int. Cl. G06F 7/00

(52) U.S. Cl. 707/1

(57) ABSTRACT

The present invention provides a management apparatus comprising a storing part adapted to control restriction of use of software and including a storage area for storing type information representing type of the restriction of use of software and a storage area for storing information representing the restriction of use, a software storing part for storing software corresponding to the storing part, and a device for altering contents of the storing part on the basis of the use of the software corresponding to the storing part.

### BACKGROUND OF THE INVENTION

1. Field of the Invention

The present invention relates to apparatus and medium for controlling utilization of software, and a medium storing the same.

2. Related Background Art

In the past, software stored in media attached to appendices of magazines have been used with restriction of term (for example, 60 days).

In a technique disclosed in Japanese Patent No. 2810033, since control information (referred to as “battery hereinafter) for controlling utilization of software is supplied from a floppy disk (referred to as “FD” hereinafter), there is a danger of duplicating the battery FD unlawfully. Further, the mailing of the FD takes a relatively long term (time lag), thereby causing risk of interruption of service. In addition, there is a danger of losing or damaging the FD.

Further, a technique disclosed in Japanese Patent Publication No. 7-89305 arises the following problems.

That is to say, there is a problem regarding use finish processing, in which, the processing is effected by a host machine, if a communication equipment such as a MODEM is malfunctioned, the use finish processing cannot be performed and unused time would also be charged. On the other hand, when the processing is effected by a user machine, if interruption of electric current occurs, the use finish processing cannot be performed at the user side not to enable calculation of use time (operation time), and, if the date of the system is manipulated during starting after the power interruption, it is difficult to detect illegality. Even if the illegality can be detected, the change of system date during the operation of application may reasonably be performed for the purpose of the system management (for example, the date is returned to 1999 Dec. 30 for an urgent countermeasure to 2000 year-trouble). In such a case, if the application cannot be used, it is very inconvenient.

Accordingly, there is the limitation of calculation of use charge effected by either the host machine or the user machine.

Further, since the charge is identical between only reference use and multi input use, the only reference use seems to be rather expensive. Namely, the charge depending upon the use cannot be effected.

### SUMMARY OF THE INVENTION

According to the present invention, (a) charging can be effected at real time, (b) there is less danger of duplication, (c) the charging can be effected automatically when a remaining amount of the battery is decreased below a predetermined amount, (d) since the battery is successively used in accordance with the usable time, the manipulation of the system date becomes meaningless, and, if the application is suddenly reduced due to interruption of electric power or the like, there is no trouble in charge processing and (e) since the battery is of so-called prepaid type, there is no time lag up to the charge, and, thus the suppler can easily raise funds. On the other hand, at the user side, a condition that the user uses excessive money (beyond the estimate) without caution can be avoided.

In order to achieve the above object, in a storage medium storing software and management software for managing the software, the present invention is characterized in that the management software includes a step for restoring and altering a management condition of the software.

In order to achieve the above object, in an information processing apparatus having memory means storing software and management software for managing the software, the present invention is characterized in that the management software includes means for restoring and altering a management condition of the software, and means for connecting to a predetermined site in order to restore the management condition of the management software by the restoring means.

In order to achieve the above object, the present invention provides an information processing apparatus comprising means for restoring and altering a management condition of management software managing software, and means for connecting to a predetermined site in order to restore the management condition of the management software by the restoring means.

In order to achieve the above object, the present invention provides an information processing apparatus comprising means for restoring and altering a management condition of management software managing software, and means for connecting to a predetermined side in order to restore the management condition of the management software by the restoring means.

In order to achieve the above object, the present invention provides an information processing apparatus comprising means for restoring and altering a management condition of management software managing software, and means for connecting to a predetermined site in order to restore the management condition of the management software by the restoring means.

In a host apparatus for restoring a management condition of management software by effecting communication with an information processing apparatus comprising means for restoring and altering the management condition of the management software managing software, and means for connecting to a predetermined site in order to restore the management condition of the management software by the restoring means, the present invention is characterized in that it includes means for sending information for restoring the management condition of the management software, in accordance with request from the information processing apparatus.

The present invention provides a managing apparatus comprising a storing part including a storage area for storing kind information representing kind of software and a storage area for storing information representing restriction of use, a software storing part for storing software corresponding to the storing part, and means for altering contents of the storing part on the basis of the use of the software corresponding to the storing part.

The present invention provides an information processing apparatus comprising means for displaying message whether control information displayed on a display is renewed or not, if a condition that the control information for controlling the use of software is to be renewed is attained, and means for displaying a picture plane required for renewal of the control information when the control information is renewed or revised.

The present invention provides an information processing apparatus comprising control means for reading-out history information regarding use of software on the basis of control information when the use of the software is controlled by the control information and for displaying validity of the control information on display means.

In a terminal device connected to a network, the present invention is characterized in that it includes control means for renewing control information for controlling use of software, upon receipt of renewal information of the control information from an information equipment connected to the network, if a condition that the control information for controlling the use of the software is to be renewed is attained.

In a system in which a terminal device is connected to an information equipment via a network, the present invention provides an information equipment comprising means for sending control information for controlling use of software to the terminal device on the basis of information sent from the terminal device.

### BRIEF DESCRIPTION OF THE DRAWINGS

FIG. 1 is a block diagram showing the whole schematic construction of the present invention.

FIG. 2 is a view showing data style in a battery supplying module;

FIG. 3 is a flow chart for explaining an embodiment of the present invention;

FIG. 4 is a flow chart showing the battery supplying module;

FIG. 5 is a view showing protocol between a user machine and a host machine;

FIG. 6 is a view for explaining a file construction of a floppy disk;

FIG. 7 is a view for explaining flow of battery program;

FIG. 8 is a view for explaining a structure of a battery floppy disk;

FIG. 9 is a view for explaining an example of display of the battery;

FIG. 10 is a flow chart for controlling the display of the battery;

FIG. 11 is a view for explaining the display of the battery;

FIG. 12 is a flow chart for estimating time/number of operation possible from a remaining amount of the battery;

FIG. 13 is a flow chart for controlling the charging of a normal battery;

FIG. 14 is a flow chart for controlling the charging of an unrestricted battery;

FIG. 15 is a flow chart for controlling the charging of a test battery;

FIG. 16 is a flow chart for controlling restriction and regeneration of use of the battery;

FIG. 17 is a view for explaining display in controlling the restriction and regeneration of use of the battery;

FIG. 18 is a flow chart for controlling whether a battery is bought or the present battery continues to be used;

FIG. 19 is a view showing a display view in battery procurement;

FIG. 20 is a flow chart for controlling whether a battery is bought or the present battery continues to be used;

FIG. 21 is a view showing a display view in battery procurement;

FIG. 22 is a flow chart for controlling on-line battery procurement;

FIG. 23 is a view showing a display view in controlling the on-line battery procurement;

FIG. 24 is a flow chart for controlling on-line battery procurement;

FIG. 25 is a view showing a display view in battery procurement;

FIG. 26 is a flow chart for controlling charge in battery invalid;

FIG. 27 is a view showing a display view in controlling the charge in battery invalid;

FIG. 28 is a flow chart for controlling charge in battery invalid;

FIG. 29 is a view showing a display view in controlling the charge in battery invalid;

FIG. 30 is a view for explaining generation of a battery from a terminal installed in a convenience store;

FIG. 31 is a view for explaining data format between the terminal and a server;

FIG. 32 is a flow chart for generating the battery;

FIG. 33 is a flow chart for generating the battery;

FIG. 34 is a system view for explaining a personal common battery;

FIG. 35 is a flow chart for generating the personal common battery;

FIG. 36 is a flow chart for controlling the personal common battery;

FIG. 37 is a view showing data format in generation of the personal common battery;

FIG. 38 is a view showing an apparatus for handling the personal common battery;

FIG. 39 is a flow chart for controlling the personal common battery (paid later type);

FIG. 40 is a flow chart for controlling the personal common battery;

FIG. 41 is a flow chart for controlling the personal common battery;

FIG. 42 is a view for explaining an apparatus in which the battery is supplied from the server;

FIG. 43 is a flow chart when the battery is supplied from the server;

FIG. 44 is a view for explaining data format;

FIG. 45 is a view for explaining data format;

FIG. 46 is a view for explaining an apparatus for generating a battery FD by a client;

FIG. 47 is a view for explaining an apparatus for managing game software by a battery;

FIG. 48 is a view for explaining an apparatus in which the battery is supplied from the server;

FIG. 49 is an initial control flow chart for controlling the apparatus of FIG. 47;

FIG. 50 is a control flow chart for controlling the apparatus of FIG. 47 under playing;

FIG. 51 is a view for explaining an apparatus for controlling game software by a battery;

FIG. 52 is a view for explaining a server for selling software controlled by the battery;

FIG. 53 is a concrete view for explaining a server for selling software controlled by the battery;

FIG. 54 is a flow chart for controlling the server for selling software controlled by the battery;

FIG. 55 is a control flow chart for checking a medium constituting the battery;

FIG. 56 is a view showing an example of display in control for checking the medium constituting the battery;

FIG. 57 is a control flow chart for checking a medium constituting the battery;

FIG. 58 is a view showing an example of display in control for checking the medium constituting the battery;

FIG. 59 is a view for explaining a medium constituting the battery; and

FIG. 60 is a view for explaining a file construction constituted by the medium constituting the battery.

### DESCRIPTION OF THE PREFERRED EMBODIMENTS

Now, preferred embodiments of the present invention will be explained with reference to the accompanying drawings.

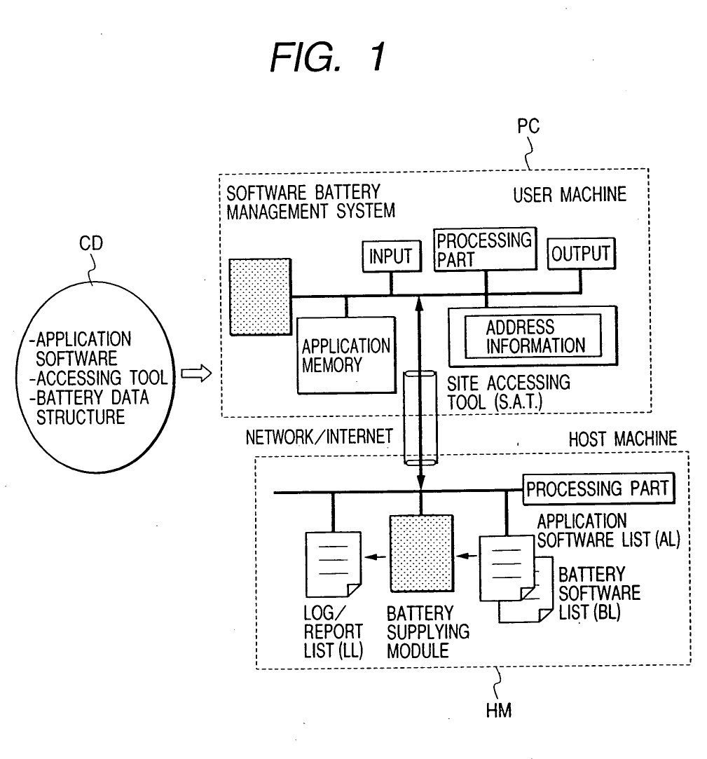

In FIG. 1, on a user machine PC including a software battery management system, a site accessing tool (hereinafter sometimes referred to as “S.A.T.”) charges a battery from a host machine (HM) in cooperation with use a system.

In the site accessing tool, information of the host machine HM to be connected is supplied to the user in a combined manner with, for example, formable storage medium CD, MD or FDD or with a semiconductor memory. When the software is supplied via communication, the communication medium may be supplied together with the software.

A battery supplying module is incorporated into the host machine MH so that the battery selected by the user is supplied to a predetermined position by a designated amount. The predetermined position is provided on the user machine PC or on a server.

FIG. 1 is a block diagram showing the present invention. In FIG. 1, in a computer (user machine) PC, at least application software set-up with down load from a storage medium CD detachably mounted to the computer and operation software for controlling valid period of the application software are stored.

The storage medium CD stores the application software and the operation software. Explaining further in detail, the operation software includes accessing tool and battery construction list. In the battery structure list, a predetermined value is set as an initial value, and, by re-writing the data value later, the application software can be used again. The operation software includes a software management system and a side accessing tool.

When the valid period of the application software on the computer PC tries to be extended, the communication with the host machine HM is effected to rewrite the above-mentioned value, thereby extending the valid period.

A memory of the host machine HM stores user log/report LL, valid period renewing module, application list AL and supplying list SL.

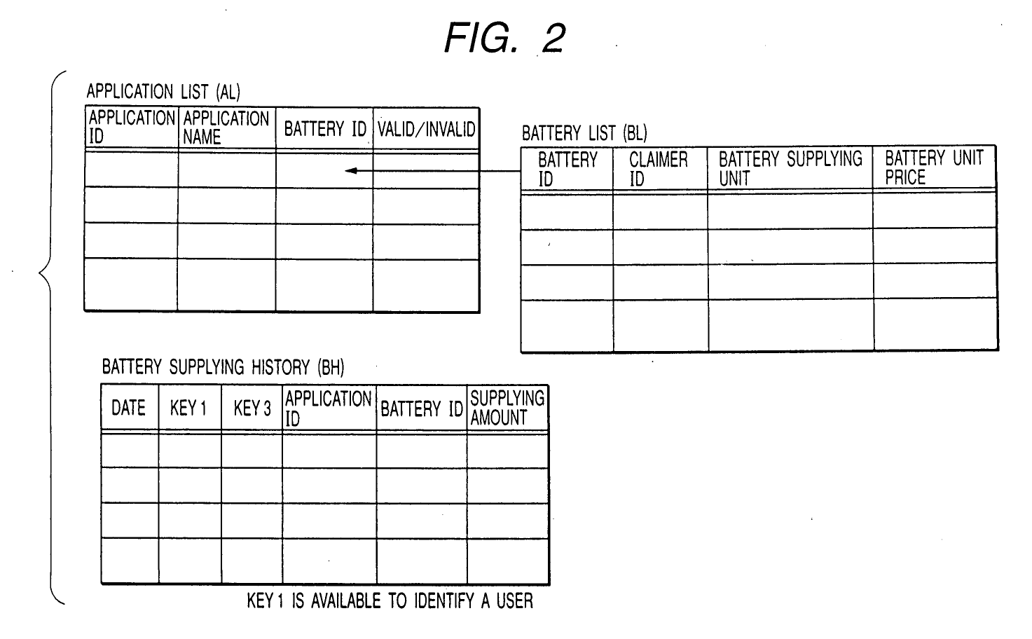

The application list AL, battery list BL and battery supplying history list BH are as shown in FIG. 2. By these lists, collation of application software and battery unit price can be set for each application.

Now, a starting sequence will be explained with reference to the following (1) to (10).

(1) The site accessing tool of the user machine is address information for information host machine included by itself and is IP address or UPL in case of inter-net. On the basis of the information, it is connected to the host machine HM.

(2) The battery supplying module of the host machine provides a list of battery informations to be supplied. Such informations are listed-up and displayed on a display device of the user machine.

(3) When the list of battery informations is received, the side-accessing tool interrogates to the software battery management system whether or not it already manages the respective batteries and divides the batteries into batteries managed and batteries not managed and displays them.

(4) The user selects a desired battery and its amount among the displayed batteries by shifting a cursor. Alternatively, a numerical value may be inputted from an input device without shifting the cursor.

(5) The site accessing tool sends the battery and its amount selected by the user to the battery supplying module.

(6) On the basis of the battery and its amount received, the battery supplying module forms additional information of the battery and sends it to the site accessing tool. Further, the information in this case is recorded as log.

(7) When the additional information of the battery is received, the site accessing tool transfers the information to the software battery management system and confirms that the battery is charged.

(8) The site accessing tool sends the confirmed information to the battery supplying module.

(9) In the battery supplying module, the confirmed information is also recorded as well as the log.

(10) When the communication sequence is finished, the communication of the site accessing tool with the host machine is ended.

Of course, after the battery is supplied, whenever the application is used on the user machine, and, ultimately, the application cannot be used.

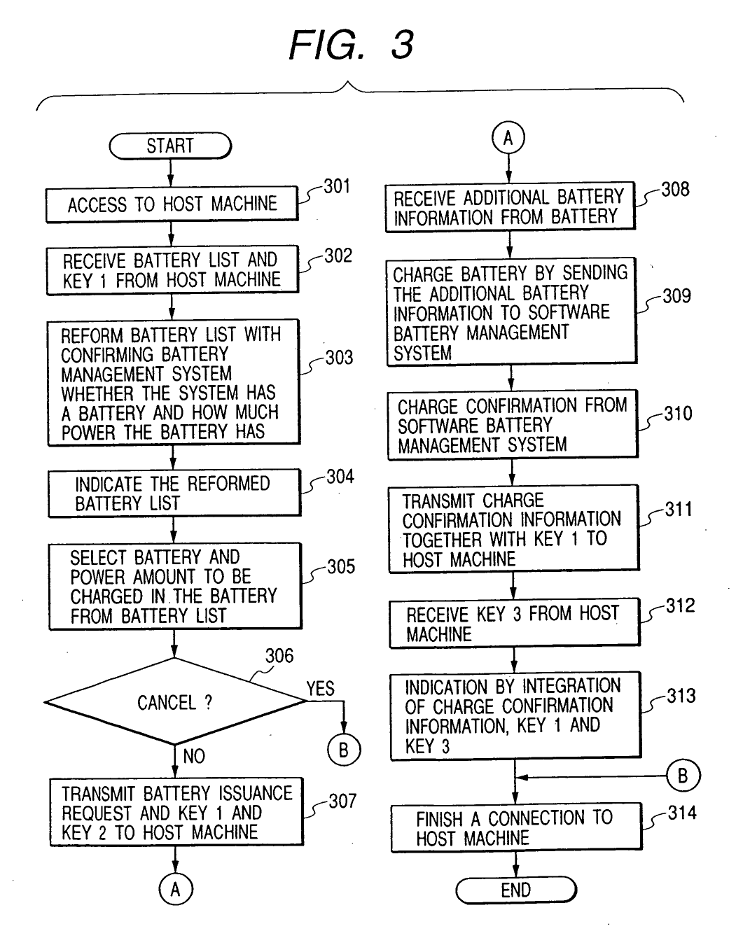

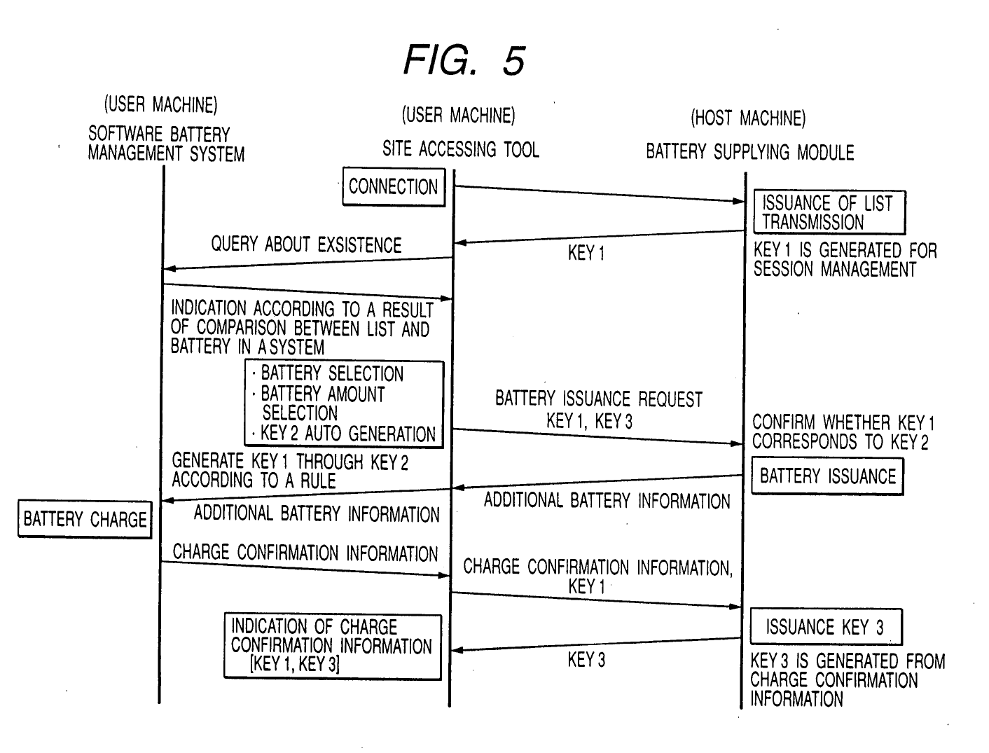

The above-mentioned process will further be explained with reference to a sequence flow shown in FIG. 5 and a control flow shown in FIG. 3. Such a control flow is control effected on the user machine PC, and program according to the control flow is stored in a memory, and the program is carried out in a processing part, thereby effecting the control.

In a step 301, access to the host machine HM is effected in accordance with the IP access or URL. After access, in a step 302, the battery list and key 1 list are received from the host machine HM. Then, in a step 303, the battery list is reformed with conforming the software battery management system whether the system has a battery and how much power the battery has. Then, in a step 304, the reformed battery list is indicated on the display of the computer PC. Then, in a step 305, the user selects the battery and power amount (battery amount) from the battery list displayed on the display by shifting a cursor by manipulating a mouse. Then, in a step 306, it is judged whether cancellation is effected or not. If continued, in a step 307, battery issuance request and keys are transmitted to the host machine HM. In a next step 308, the additional battery information is received from the host machine HM. In a step 309, the battery is charged by sending the additional battery information to the software battery management system. In a step 310, charge confirmation information is received from the software battery management system. In a step 311, the charge confirmation information is sent to the host machine HM together with the key 1. In a step 312, key 3 is received from the host machine HM.

In a step 313, charge confirmation information, key 1 and key 3 are combined, and obtained integration is indicated for user's confirmation. In a step 314, a connection to the host machine HM is finished.

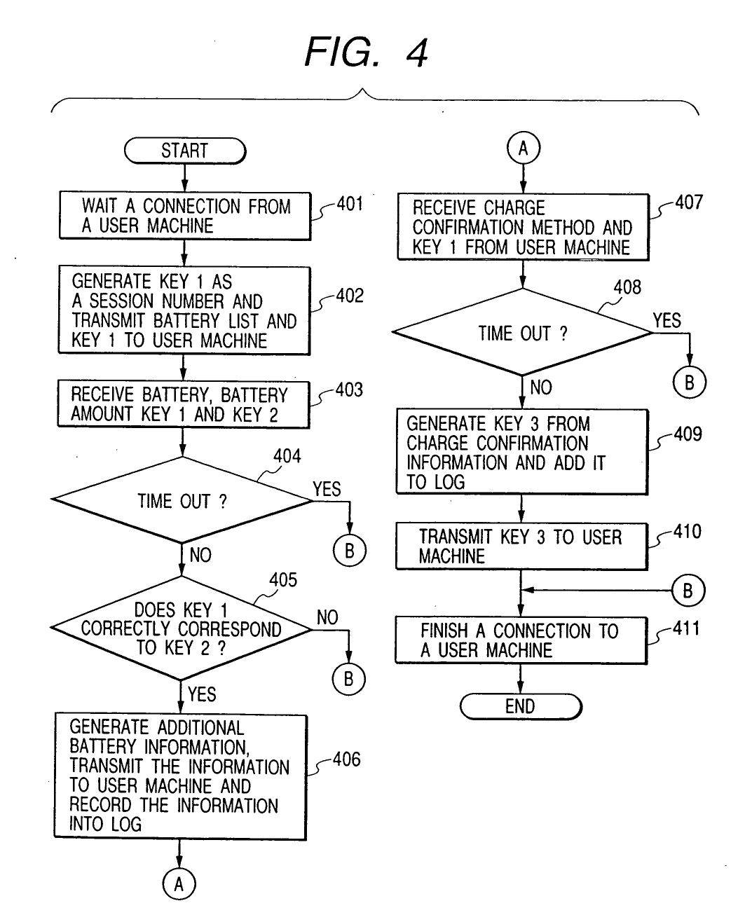

Next, the battery supplying module will be explained on the basis of FIG. 4 with reference to the sequence of FIG. 5. Such a control flow is control effected on the host machine HM, and program according to the control flow is stored in a memory, and the program is carried out in a processing part, thereby effecting the control. The following steps are carried out by the processing part.

In a step 401, a connection from the user machine PC is waiting. In a step 402, a key as a session number is generated and the battery list and key 1 are transmitted to the user machine PC. In a step 403, the battery amount, key 1 and key 2 are received from the user machine PC. In a step 404, it is judged whether there is time out or not. If no time out, in a step 405, it is judged whether the key 1 corresponds to the key 2. If Yes, in a step 406, the additional battery information is generated and is sent to the user machine PC and is recorded to the log. In a step 407, the charge confirmation information and key 1 are received from the user machine PC. In a step 408, it is judged whether there is time out or not. If No, in a step 409, key 3 is generated from the charge confirmation information and is added to the log. In a step 410, the key 3 is sent to the user machine PC.

Then, in a step 411, a connection to the user machine PC is finished.

After the battery is charged by such connection, the application is carried out. By carrying out the application, the re-charging is effected in the similar manner to that as mentioned above, and, the application is carried out again.

Next, other embodiments of the battery used in the above-mentioned embodiment will be described.

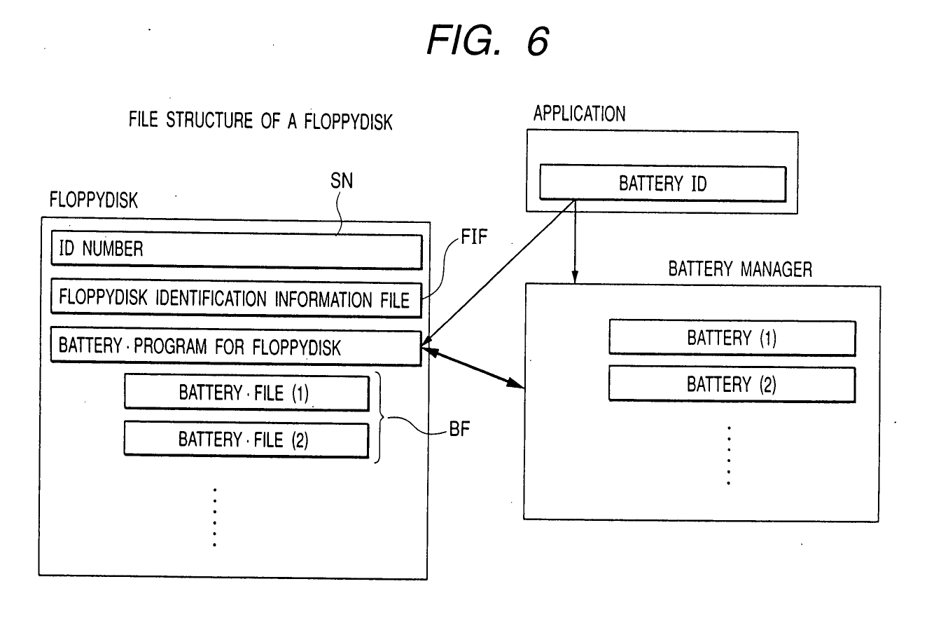

As a member for controlling the use of the software, a floppy disk for storing the information for controlling the use of the software is used, and such a floppy disk is called as “battery” since it controls the use of the software. As shown in FIG. 6, a structure of the battery includes an area for storing an ID number of the floppy disk, an area for storing floppy disk identification information file FIF, i.e., information for judging whether the floppy disk is correct or illegal (for example, judging whether the floppy disk is formed illegally or not), and an area for storing floppy disk battery program. The battery program is program having a function for effecting communication with a battery manager of the user machine in supplementation/extraction of the battery and for selectively handling the application battery as an initial action source. When this program is read out, battery ID and operation mode (either supplementation or extraction) are designated as a starting parameter.

Further, an area for storing the battery file BF is also provided. This area stores a coded file comprised of combination of capacity of the battery and information for checking collation of data. Plural filed may be provided.

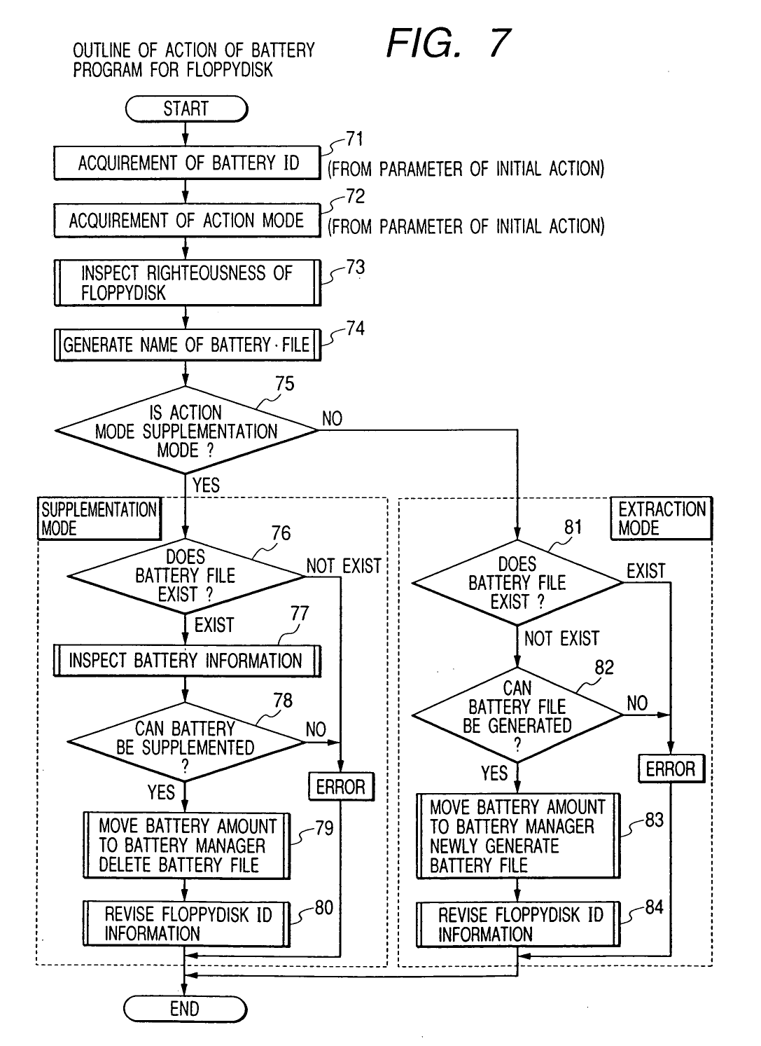

FIG. 7 is a flow chart showing the above-mentioned battery program, which is stored in the user machine and is carried out in the processing part of the user machine PC of FIG. 1.

Now, the operation will be described along the flow chart. Such a control flow is control effected on the user machine PC, and program according to the control flow is stored in a memory, and the program is carried out in a processing part, thereby effecting the control. The following steps are carried out by the processing part.

In a step 71, the battery ID is acquired from a parameter of initial action and is written in the area storing the battery program. Then, in a step 72, an action mode is acquired. Then, in a step 73, the data of the storage area for inspecting rightness of the floppy disk is read out and the contents thereof is confirmed in the processing part. Then, the program goes to a step 74, where name of the battery file is generated. Then, the program goes to a step 75, where it is judged whether the action mode is a supplementation mode or not. If supplementation mode, the program goes to a step 76, where it is checked whether there is the battery file in the floppy disk or not. If exists, the program goes to a step 77, where the battery information is inspected. When the inspection is finished, it is checked whether the battery can be supplemented or not, and the program goes to a step 79. The battery amount is transferred to the battery manager of the user machine PC. The file of the floppy disk is deleted. Then, the floppy disk identification information is revised or renewed. If the action mode is an extraction mode, the information is picked up from the floppy disk to check whether or not there is the battery file. If not exist, it is checked whether the battery file can be generated or not. If Yes, the battery file is generated, and the battery amount is shifted from the battery manager. Then, the floppy disk identification information is revised.

With the arrangement as mentioned above, by storing the identification information, the illegal copying of the floppy disk can be prevented.

Further, by storing the program in the floppy disk, self-checking of the format information of the floppy disk can be made.

Further, the collation of the battery information can be self-checked.

By effecting the communication with the battery manager of the user machine, the battery can selectively be handled.

By version-up of the program, the secret of the battery information of the floppy disk can be enhanced.

Further, a plurality of battery files can be formed in the single floppy disk.

Next, a further embodiment of the battery will be explained.

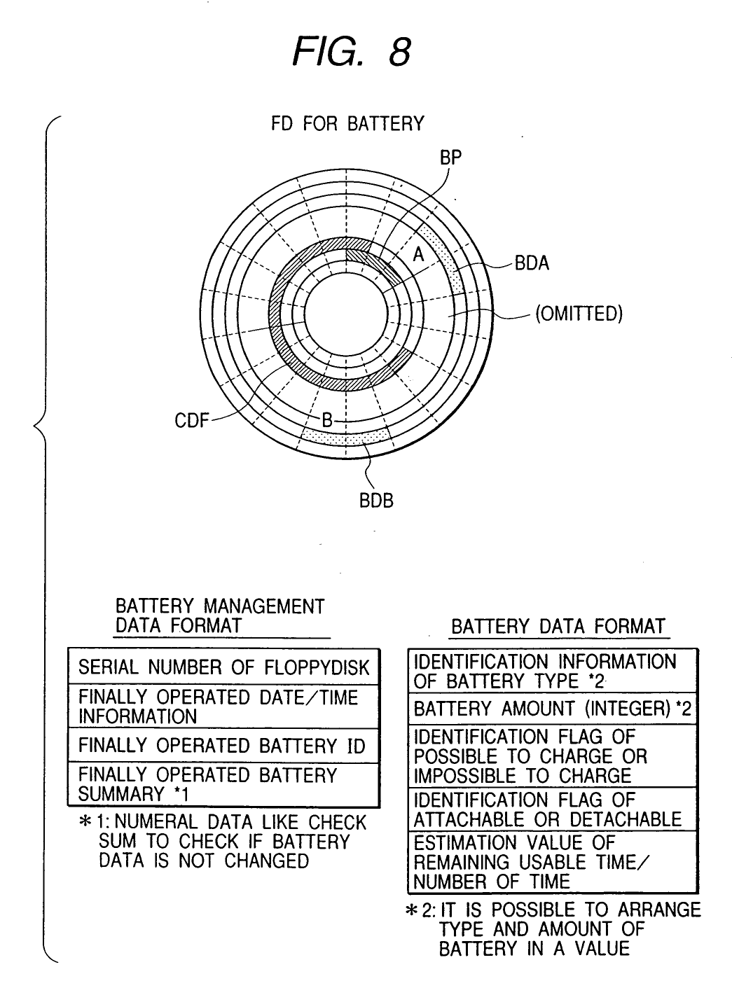

FIG. 8 is an explanatory view for generating the kind of the battery.

In FIG. 8, an example that the floppy disk is generated for special use for the battery will be explained. In FIG. 8, an area storing the battery program is designated by BP. An area CDF serves to store management data file. An area BDA serves to store battery data. Battery data A is stored there, and data for controlling application program A and carried out at a predetermined time is stored. Here, it is normally referred to as battery.

In an area BDB, battery data B is stored, and data for controlling application program and usable in an unrestricted manner is stored. Here, it is referred to as unrestricted battery.

As shown in FIG. 8, the format of the management data file includes an area for storing the serial number of the floppy disk, an area for storing lastly operated date/time information, an area for storing lastly operated battery ID, and an area for storing lastly operated battery summary. The battery data format includes an area for storing identification information for discriminating the types of battery (here, information for discriminating three types, i.e., “test”, “normal” and “unrestricted” is assigned), an area for storing battery amount (capacity), an area for storing identification flag of possible to charge or impossible to charge, an area for storing identification flag of attachable or detachable, and an area for storing an estimation value of remaining usable time/number of time.

When the battery information is acquired, there is a method in which the battery information is once recorded in a certain medium and the information is obtained indirectly via such medium. In this method, by limiting the medium capable of recording the battery information to a recording medium having special format, the copying of the battery information effected by the user can be prevented.

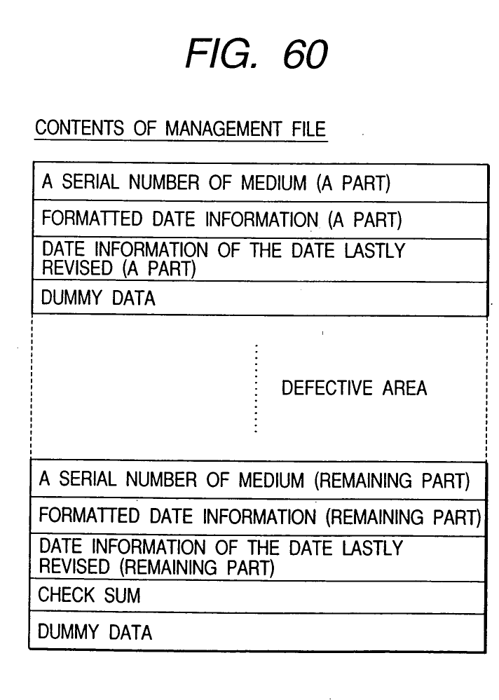

For example, the battery format may be formed as shown in FIG. 59, thereby preventing accidental duplication. In this format, DF is entire management file, DS1 is normal sector in the management file, and DS2 is defective sector in the management file. With this arrangement, by providing the defective area in the management file, when the entire management file is read out, since error is generated, the reading-out is made impossible. The information of the management file forms correct information by totalizing informations before and after the defective area. The informations stored in the sectors before and after the defective area are coded. Further, the management file has a construction as shown in FIG. 60.

By constructing the file as mentioned above, when the medium is copied, normally, standard format information is designated and copy side data is read, and the data is duplicated at a copied side. By adopting the special format exclusive for the battery, since there is a portion different from the standard format, the format cannot copied by copy command prepared in OS.

Further, medium specific data for identifying the media is stored in the constructural media in the management file.

The medium specific data is data for identifying respective media to one and, more specifically, is by gathering “a serial number of medium”, “formatted date information” and “date information of the date lastly revised” in the management file into one.

By a combination of the serial number of the medium and the formatted date information, the medium is identified. By the date information of the date lastly revised, the time-lapse use history is discriminated.

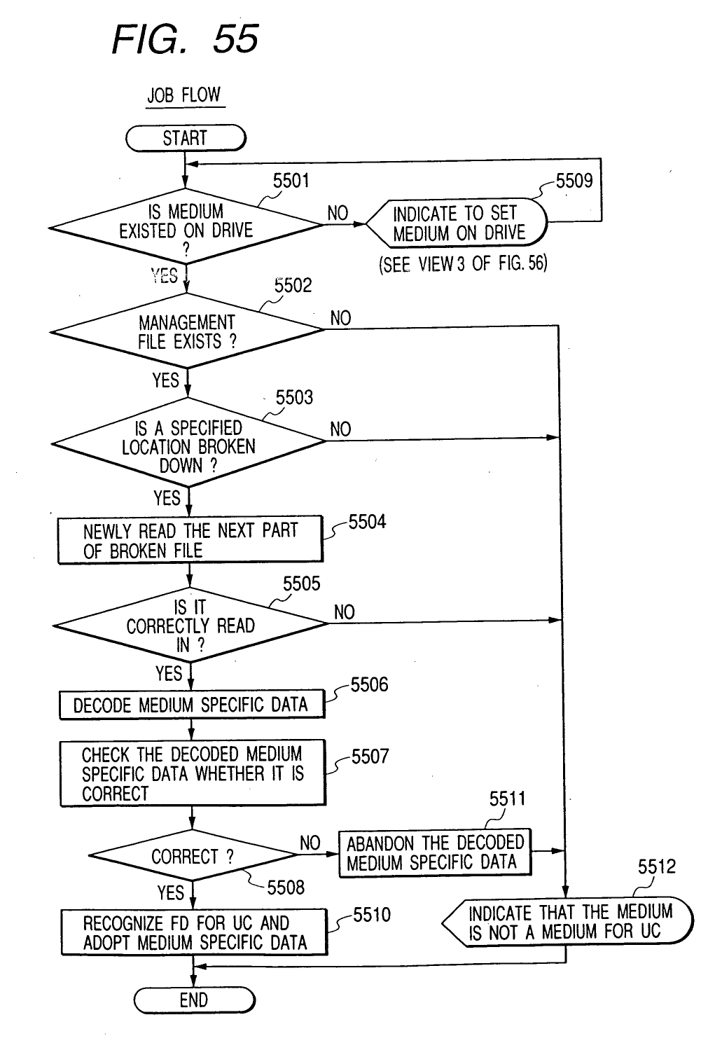

Now, identification control effected when the recording medium for special use is used will be explained with reference to FIGS. 55 to 58. Such a control flow is control effected on the user machine PC, and program according to the control flow is stored in a memory, and the program is carried out in a processing part, thereby effecting the control. The following steps are carried out by the processing part.

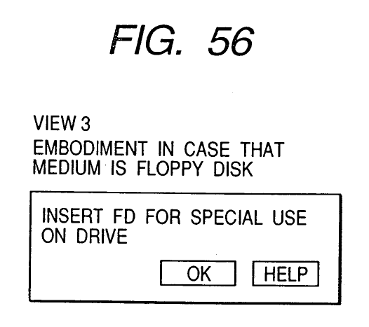

In FIG. 55, in a step 5501, it is checked whether the recording medium is set in a driving apparatus. If No, in a step 5509, display regarding insertion of the recording medium is indicated on the display as shown in FIG. 56. On the other hand, if Yes, then the management file of the recording medium is read out, and, in a step 5502, it is checked whether the management file exists or not. If Yes, in a step 5503, it is checked whether a specified location is broken down or not.

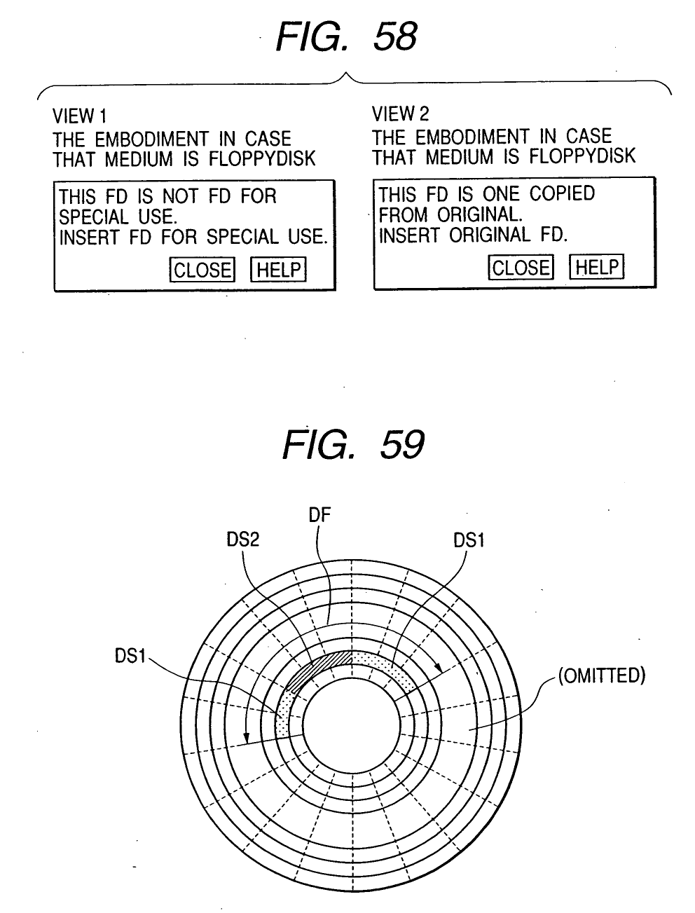

Continuation of the file is newly read from the next part of broken file. Thereafter, in a step 5505, it is checked whether it is correctly read-in or not. If Yes, in a step 5506, the medium specific data is decoded and read out, and it is checked whether the decoded medium specific data is correct or not. In a step 5508, if it is judged as “correct, the data is read-in as the correct data, and the processing is finished. In the step 5508, if No, the decoded medium specific data is abandoned, and display “view 1” of FIG. 58 is indicated on the display, and the processing is finished.

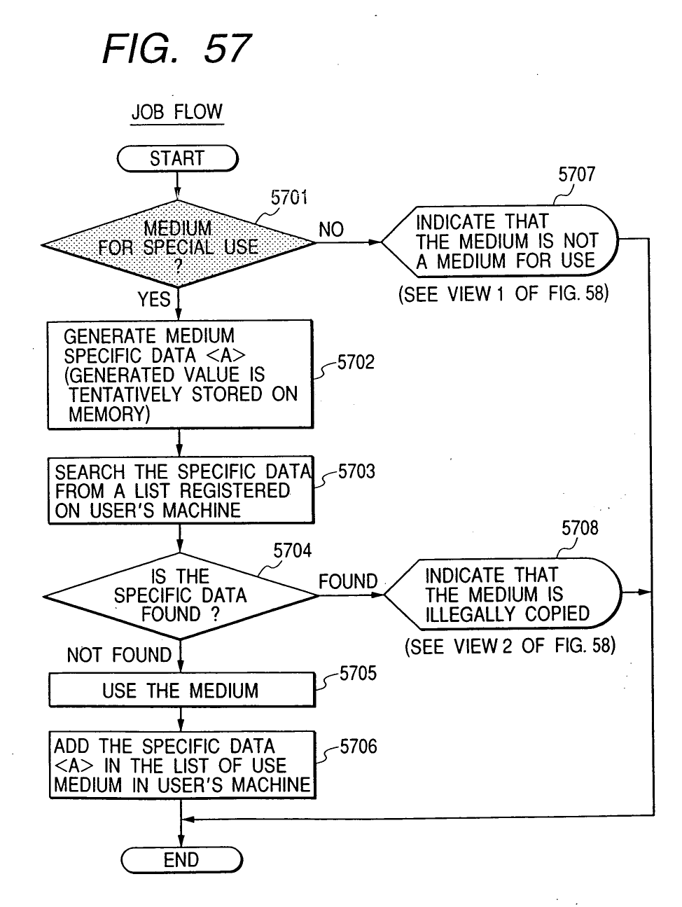

Next, control flow shown in FIG. 57 will be explained. Such a control flow is control effected on the user machine PC, and program according to the control flow is stored in a memory, and the program is carried out in a processing part, thereby effecting the control. The following steps are carried out by the processing part.

In a step 5701, it is checked whether the medium is a medium for special use. If No, as shown in a step 5707, the display is indicated on the display as “view 1” in FIG. 58. If Yes, in a step 5702, the medium specific data is generated. The generated data is stored in the memory. Thereafter, the specific data is retrieved from the a list of use media registered on the user's machine. If the data is not found in the step 5704, in a step 5705, the medium is used. In the step 5704, if No, the display representing the illegal copy is indicated, for example, as “view 2” in FIG. 58, and the processing is finished.

By the above-mentioned processing, the rightness of the recording medium is checked.

Next, the usage of the above-mentioned battery will be explained.

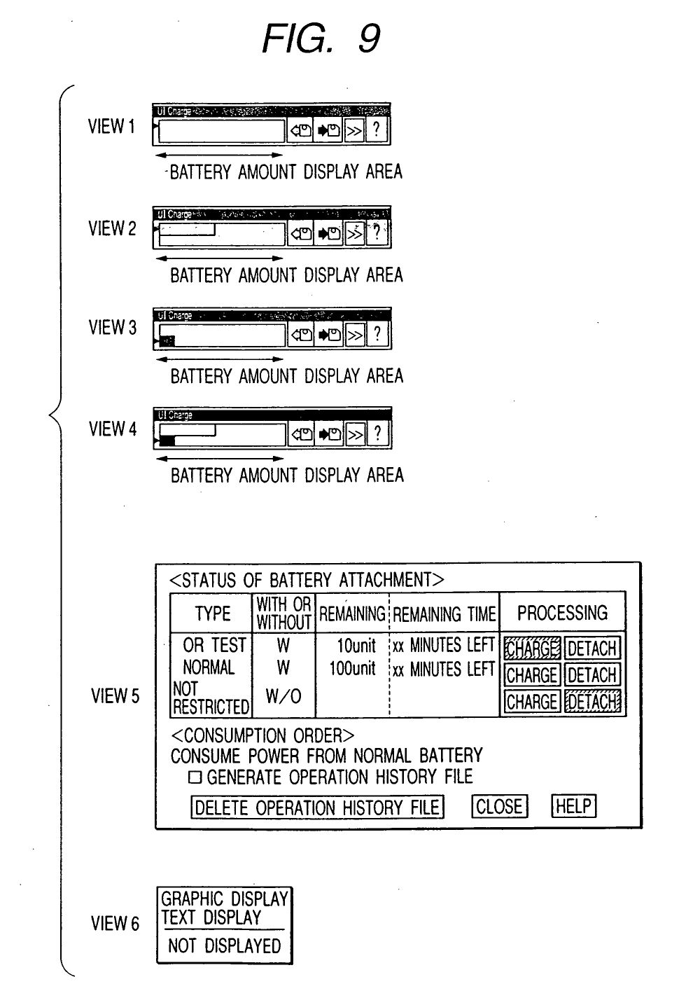

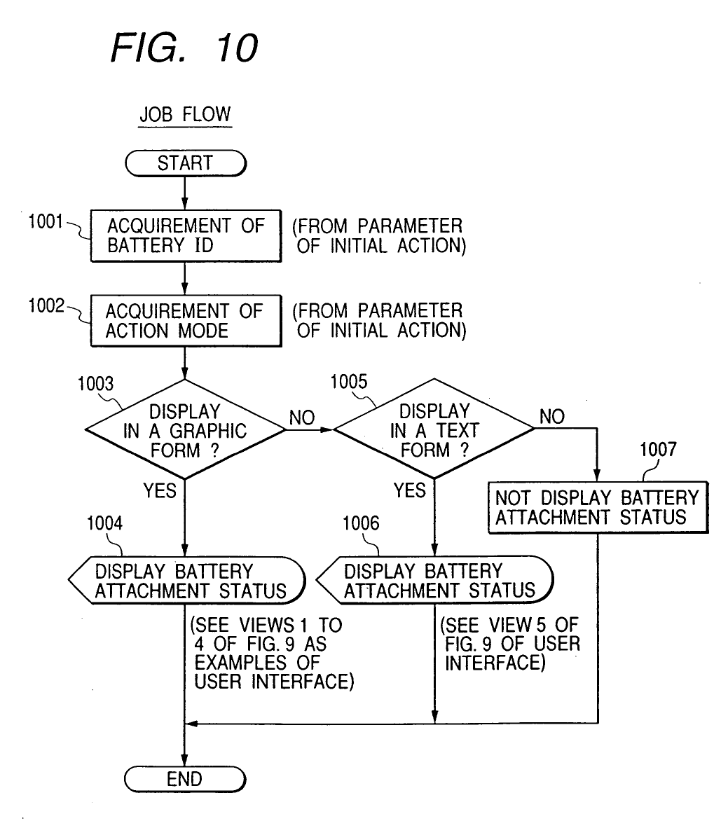

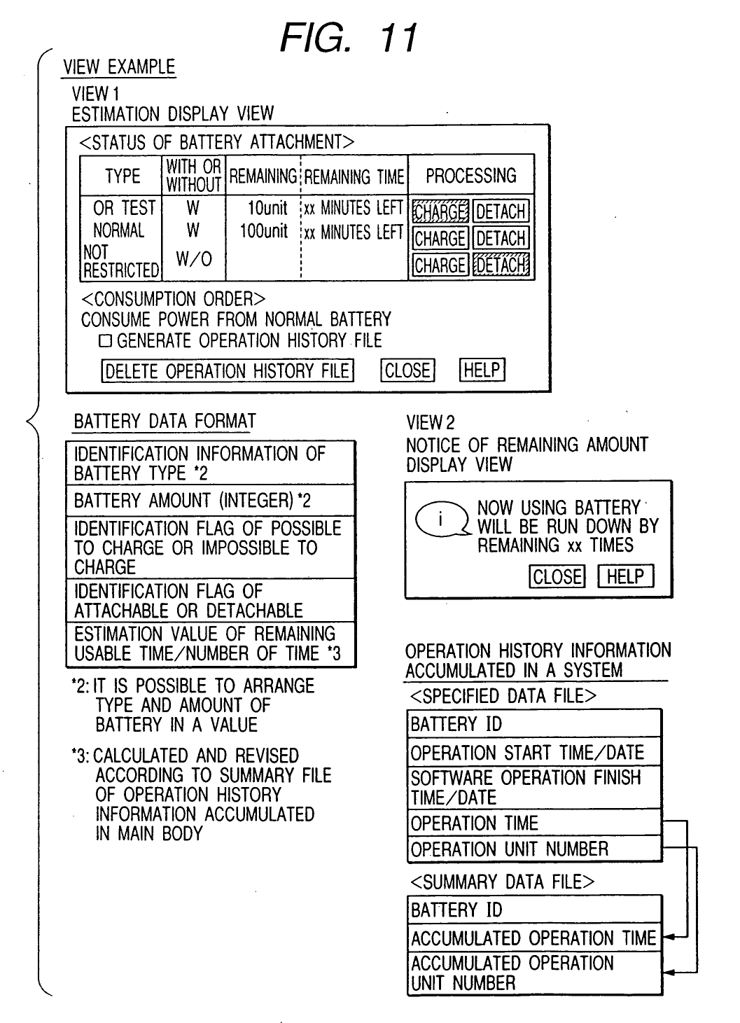

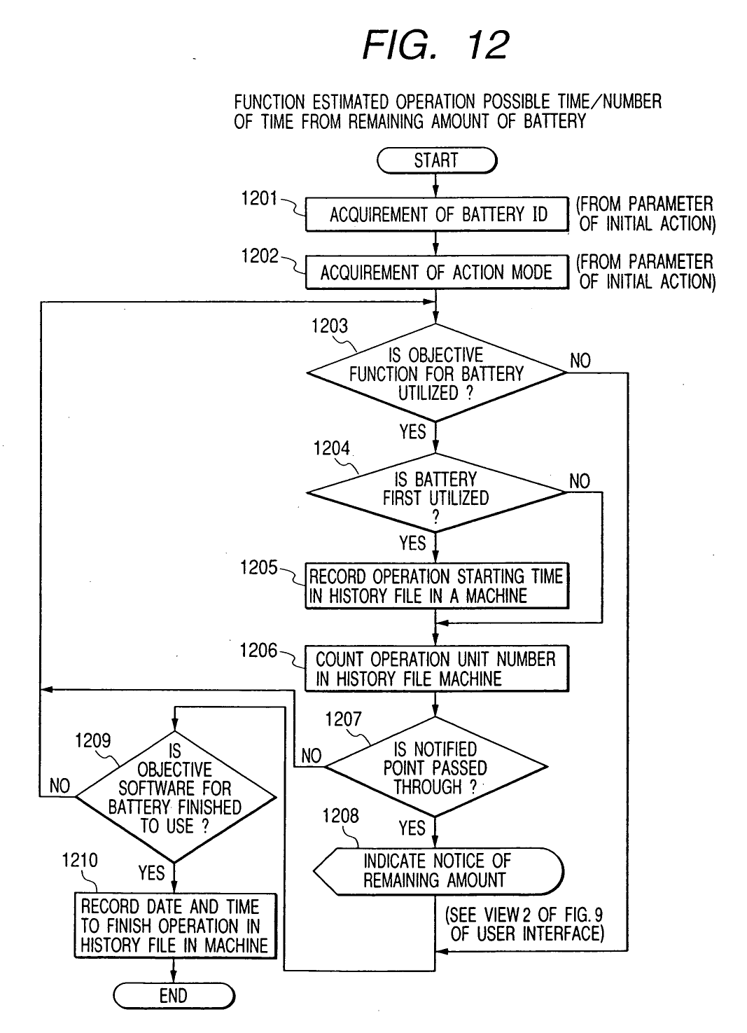

FIG. 9 shows an example of indication when the battery is being used.

In FIG. 9, a “view 1” is an explanatory view showing a condition that the unrestricted battery or the normal battery having full capacity is attached to the equipment.

A “view 2” is an explanatory view showing an example that a single normal battery having consumption of about 55% is attached.

A “view 3” is an explanatory view showing an example that a single test battery is attached to the equipment.

A “view 4” is an explanatory view showing a condition that a normal battery and a test battery are attached.

A “view 5” is test indication and is an explanatory view showing a battery mounted condition and indicates or displays status of the battery being attached and having application being used. It is designed to indicate which battery is being consumed.

A “view 6” is a view for explaining an indication example in which display style can be selected between graphic display and text display.

FIG. 10 is a view showing control flow chart for controlling the display of the above-mentioned battery. Such a control flow is control effected on the user machine PC, and program according to the control flow is stored in a memory, and the program is carried out in a processing part, thereby effecting the control. The following steps are carried out by the processing part.

Here, the display control is described with reference to FIG. 10.

In a step 1001, the battery ID is acquired. Then, the action mode is acquired. Then, in a step 1003, it is judged whether the display is the graphic display or not. If the graphic display is selected, the processing for displaying the status of the battery attachment is effected, and the display data as shown in FIG. 9 is generated and displayed. In the step 1003, if No, it is judged whether the display is text style or not. If so, in a step 1006, the display data of the status of attachment is generated and is displayed as “view 4” in FIG. 9.

In the step 1005, if No, the processing is finished without effecting the display control for the status of attachment.

Next, use estimation of the battery attached to the machine will be explained.

FIG. 11 shows display view for use estimation of the battery.

A “view 1” shows one of the estimation views, and “view 2” shows another example of the estimation view.

In order to effect the estimation, the data format of the battery is constituted as shown.

The data format is constituted to includes an area for storing the battery type identification information, an area for storing the battery amount, an area for storing identification flag of possible to charge or impossible to charge, an area for storing identification flag of attachable or detachable, and an area for storing an estimation value of remaining usable time/number of time. Further, there are provided areas for storing battery ID, operation start time/date, software operation finish time/date, operation time and operation unit number as operation history information accumulated in the system.

Further, there are provided areas for storing battery ID, accumulated operation time and accumulated operation unit number as summary data file.

Next, the processing for estimating operation possible time/number of time from the control flow shown in FIG. 12 will be explained. Such a control flow is control effected on the user machine PC, and program according to the control flow is stored in a memory, and the program is carried out in a processing part, thereby effecting the control. The following steps are carried out by the processing part.

In a step 1201, the battery ID is acquired, and, in a step 1202, the action mode is acquired, and then the program goes to a step 1203, where it is judged whether an objective function for the battery is utilized or not. If Yes, the program goes to a step 1204, where it is judged whether the battery is firstly utilized after the initial action. If Yes, in a step 1205, the operation starting time is recorded in the history file of the machine. In a next step, the operation unit number is counted in the history file of the machine. In a step 1206, it is judged whether a notified point is passed through or not. If passed, in a step 1208, the processing for notice of remaining amount is effected and the notice is indicated on the display. Then, in a step 1209, it is judged whether the objective software for battery is finished to use or not. If No, the program is returned to the step 1203, and the above-mentioned processing is repeated. On the other hand, if finished, the program goes to a step 1210, where the operation finish date/time is recorded in the history file of the machine, and the processing is finished.

Next, the processing for charging the battery will be described with reference to the accompanying drawings.

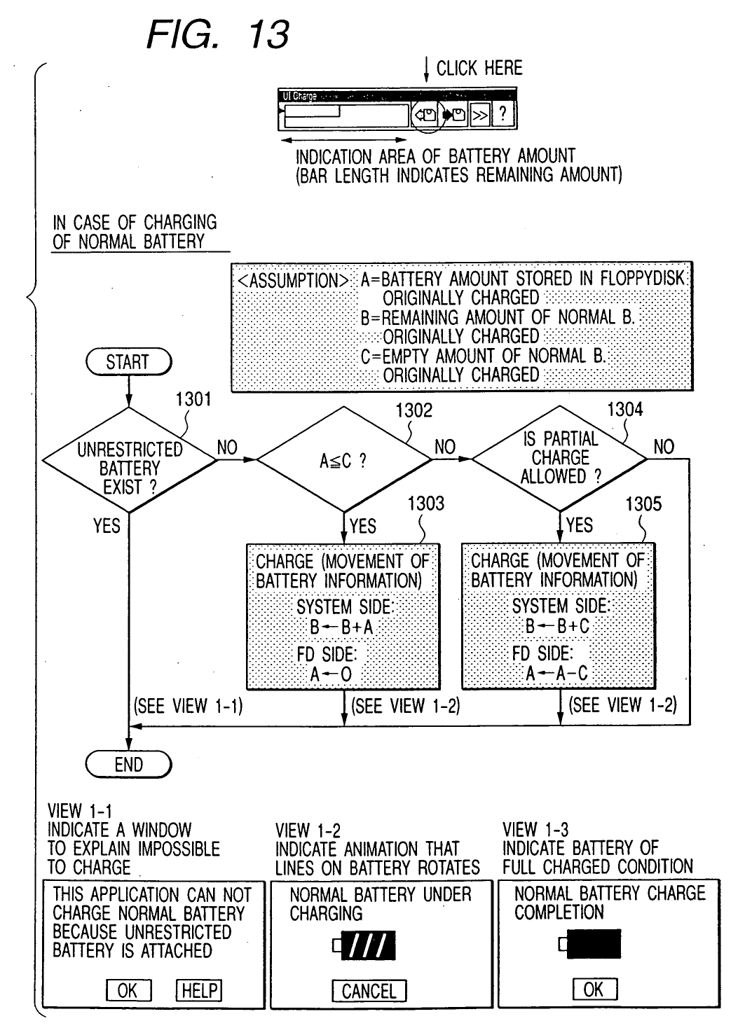

FIG. 13 is a flow chart showing the charging. Such a control flow is control effected on the user machine PC, and program according to the control flow is stored in a memory, and the program is carried out in a processing part, thereby effecting the control. The following steps are carried out by the processing part. The explanation is made with reference to FIG. 13.

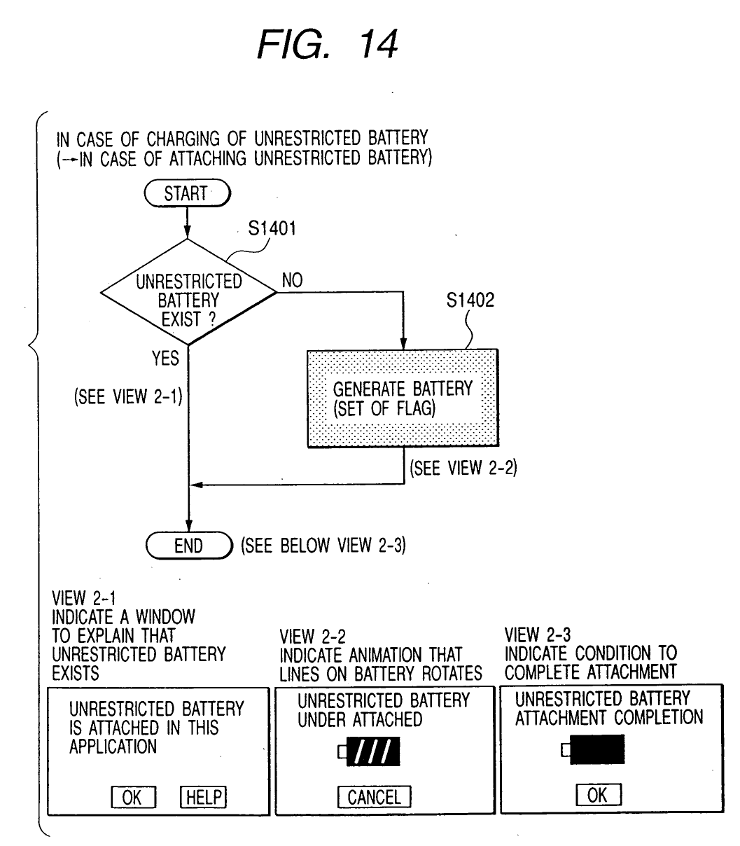

In a step 1301, it is judged whether the battery to be charged is the unrestricted battery or not. If the unrestricted battery, the charging processing is finished. On the other hand, if not so, the program goes to a step 1302, where the checking of the remaining amount is effected. If the remaining amount is great, in a step 1303, the charging processing is effected, and, after the charging is completed, the charging processing is finished. In a step 1304, it is judged whether partial charge is allowed or not. If Yes, in a step 1305, the charging processing is effected, and, after the charging is completed, the charging processing is finished. Next, a case where the unrestricted battery is charged will be explained with reference to FIG. 14.

In a step 1402, it is judged whether the unrestricted battery is attached or not. If Yes, as shown, the fact that the unrestricted battery is attached is outputted to the display view, and the program is ended. In the step 1401, if there is no restricted battery, a battery is generated, and message as shown is indicated, and further, message representing completion of attachment is indicated.

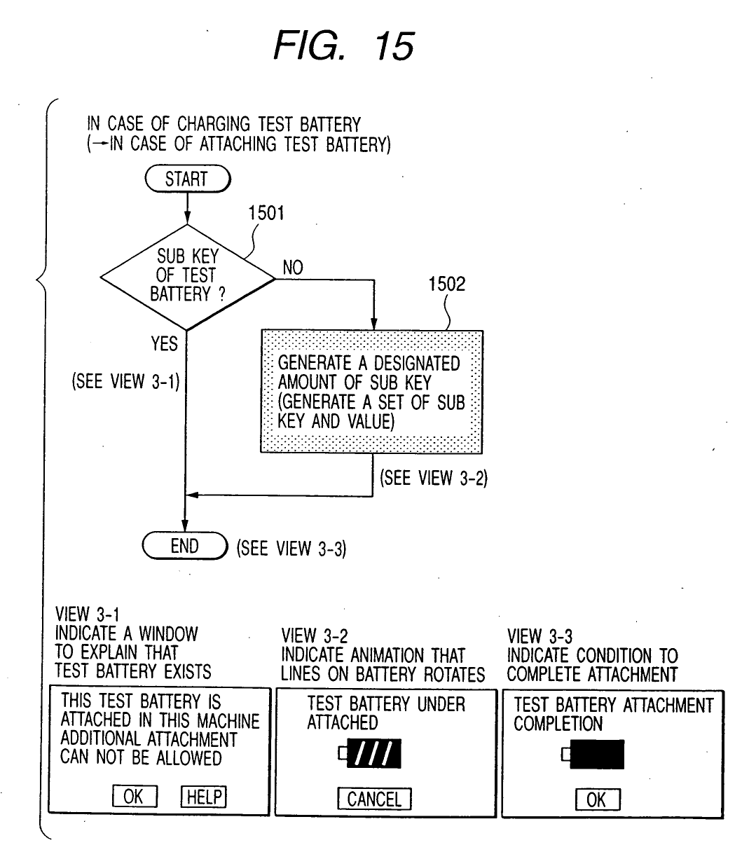

Next, control flow for charging the test battery will be explained with reference to FIG. 15. Such a control flow is control effected on the user machine PC, and program according to the control flow is stored in a memory, and the program is carried out in a processing part, thereby effecting the control. The following steps are carried out by the processing part.

In a step 1501, it is judged whether a sub key of the test battery is attached or not. If Yes, the message as shown is indicated, and the program is ended. In the step 1501, if No, the sub key of the test battery is generated with a designated amount. In this case, message “under attached” as shown is indicated during the generation, and message “attachment completion” as shown is indicated upon completion of the charging.

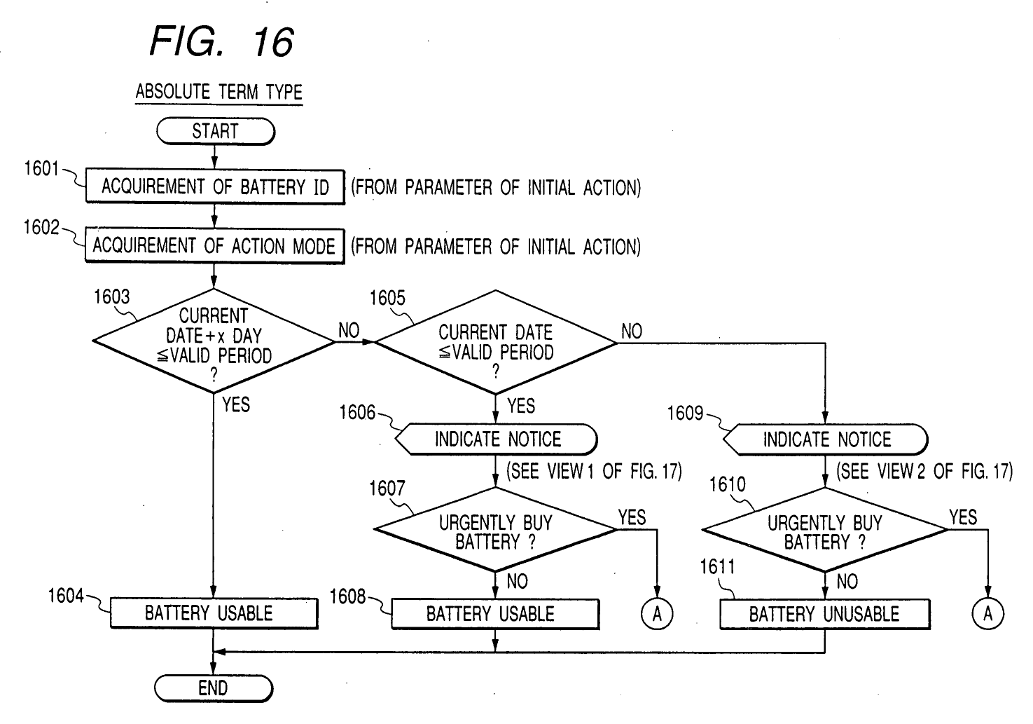

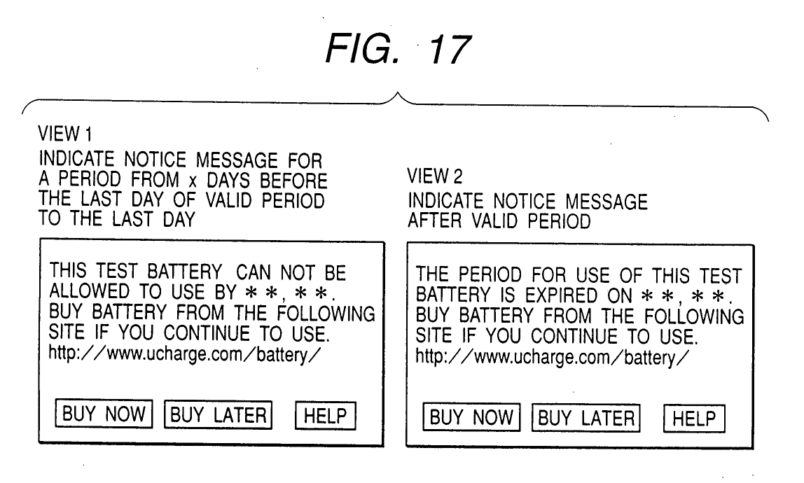

FIG. 16 shows control flow regarding processing for reproducing the battery when the operation limitation of the battery is reached. Such a control flow is control effected on the user machine PC, and program according to the control flow is stored in a memory, and the program is carried out in a processing part, thereby effecting the control. The following steps are carried out by the processing part.

Explanation is made with reference to FIG. 16. First of all, in a step 1601, the battery ID is acquired. Then, in a step 1602, the action mode is acquired. In a next step 1603, current date is compared with valid period. If Yes, because of battery usable, the processing for checking whether the battery is usable or not is finished. In the step 1603, if No, in a step 1605, the current date and the valid period are further checked. If Yes, in a step 1606, data for notice indication is generated and is indicated on the display. Then, if urgently buy battery” is selected, the program is transferred to battery buying routine; whereas, if No, since the battery can yet be used, in a step 1608, the processing regarding battery usable is effected, and then the processing is finished. In the step 1605, if No, in a step 1609, data for notice indication is generated and is indicated on the display, and then, in a step 1610, it is checked whether the view is clicked or not, and processing whether the program goes to the buying routine or the machine is operated is effected, and, after such processing is finished, the program is ended.

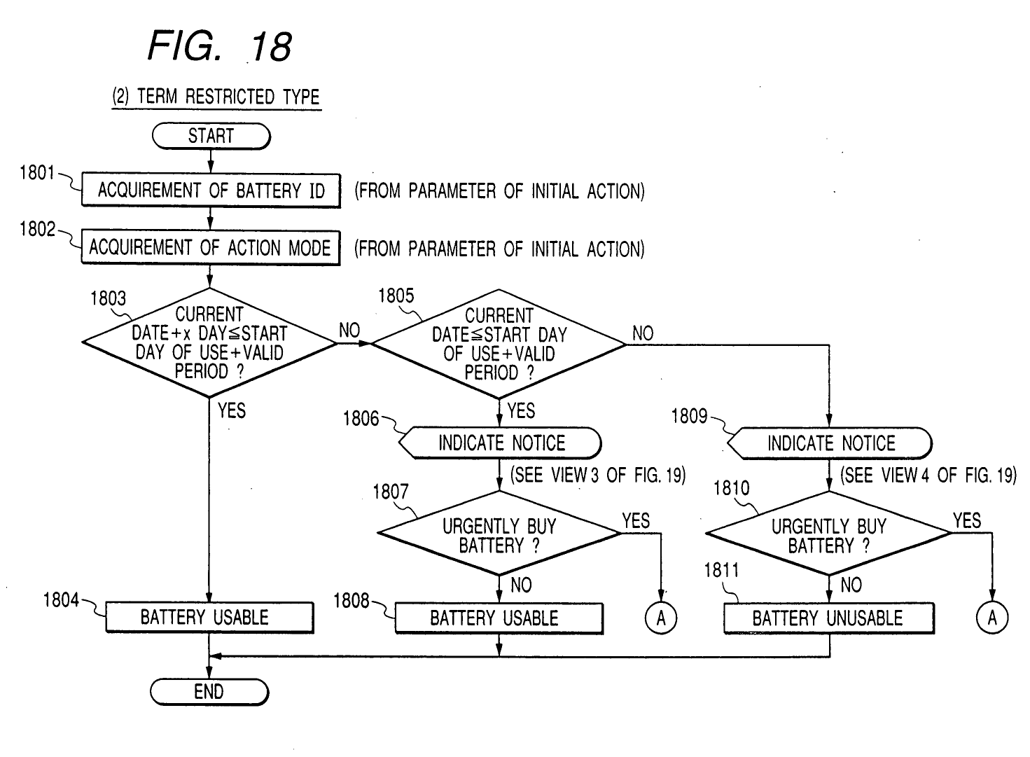

FIG. 18 shows a flow chart for checking whether the battery is bought or the battery continues to be used in the battery of term restricted type. Such a control flow is control effected on the user machine PC, and program according to the control flow is stored in a memory, and the program is carried out in a processing part, thereby effecting the control. The following steps are carried out by the processing part.

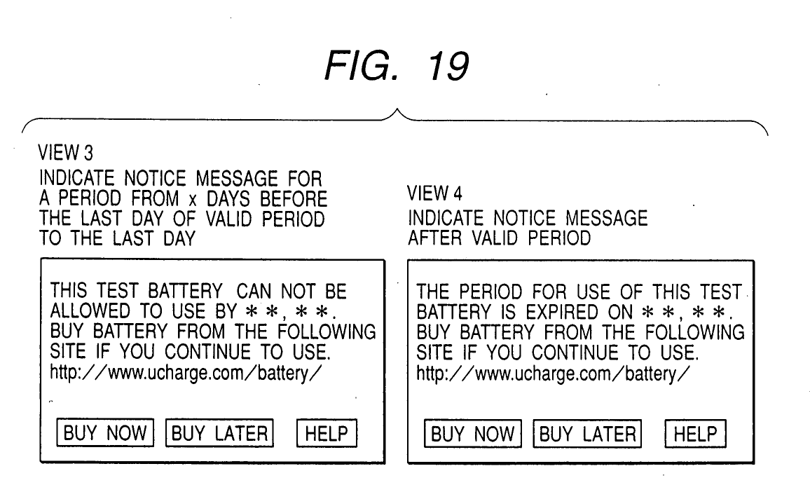

In FIG. 18, in a step 1801, the battery ID is acquired, and then, in a step 1802, the action mode is acquired. Thereafter, in a step 1803, current day+x day and start day of use+valid period are compared. If Yes, since the battery is usable, the processing is effected in a step 1804, and the program is ended. In the step 1803, if No, in a step 1805, the current day is compared with start day of use+valid period. If Yes, in a step 1806, notice indication as shown in FIG. 19 is effected, and the processing regarding instruction “urgently buy the battery” or “buy the battery later” is effected. If “urgently buy the battery”, the buying processing is effected; whereas, if No, in a step 1808, the processing regarding the battery usable is effected, and then, the program is ended. If No, in the step 1805, in a step 1809, notice indication is effected, and then, instruction waiting processing is waited, and the above-mentioned processing is effected in accordance with the instruction, and then the processing is finished.

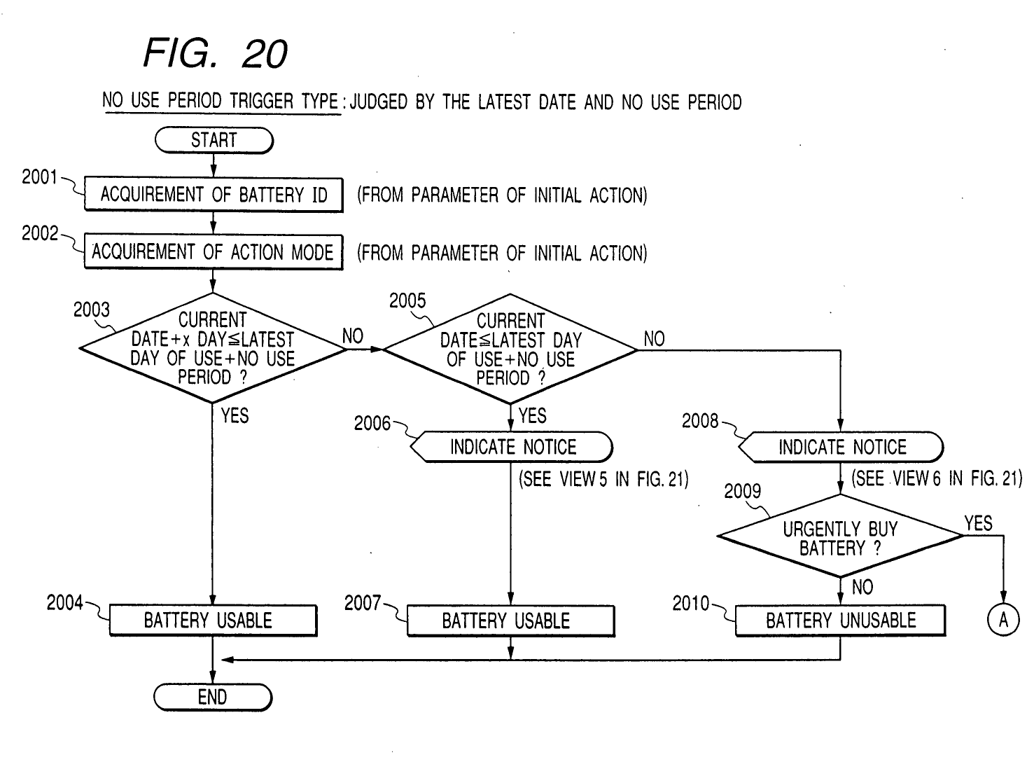

Next, control processing whether continuation of use of no use period trigger type or buying the battery is selected will be explained with reference to FIG. 20. Such a control flow is control effected on the user machine PC, and program according to the control flow is stored in a memory, and the program is carried out in a processing part, thereby effecting the control. The following steps are carried out by the processing part.

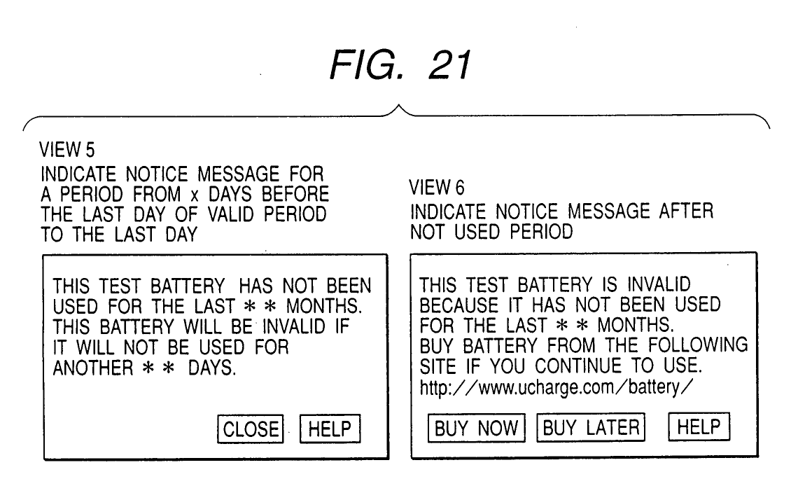

In FIG. 20, in a step 2001, the battery ID is acquired, and then, in a step 2002, the action mode is acquired. Thereafter, in a step 2003, current day+x day and latest day of use+no use period are compared. If Yes, since the battery is usable, the processing is effected in a step 2004, and the program is ended. In the step 2003, if No, in a step 2005, the current day is compared with latest day of use+no use period. If Yes, in a step 2006, notice indication as shown in FIG. 21 is effected, and, in a step 2007, the processing of battery usable is effected, and the program is ended. In the step 2005, if No, in a step 2008, notice indication is effected, and, as shown in FIG. 19, the instruction waiting processing is effected, and, it is judged whether “urgently buy the battery” or not. If No, the processing of battery unusable is effected; whereas, if Yes, the processing for transferring to the buying routine, and the program is ended.

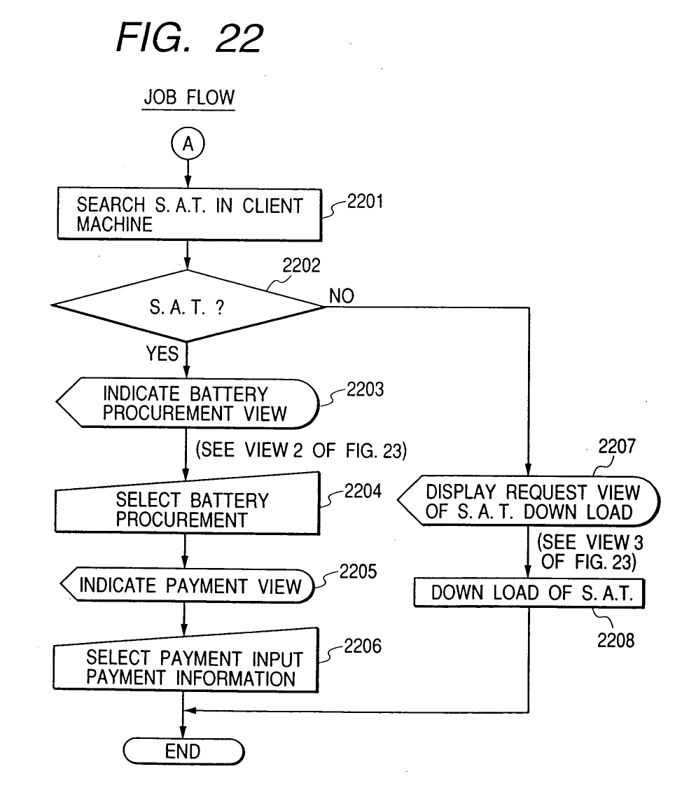

FIG. 22 is a flow chart showing battery buying (procurement) processing. Such a control flow is control effected on the user machine PC, and program according to the control flow is stored in a memory, and the program is carried out in a processing part, thereby effecting the control. The following steps are carried out by the processing part. The processing will be described with reference to FIG. 22.

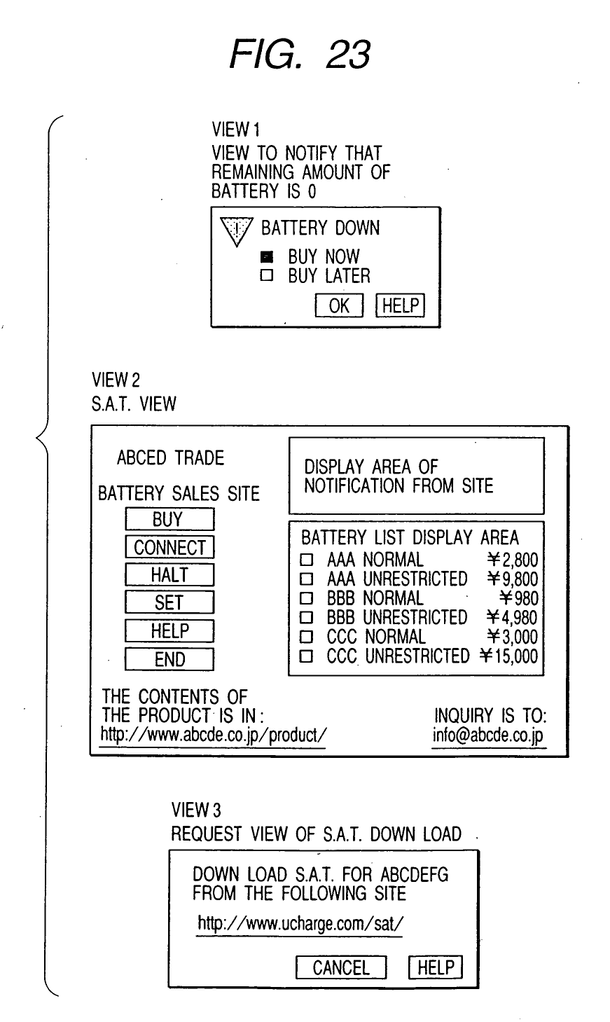

In FIG. 22, in a step 2201, it is searched whether there is S.A.T. in the client machine, and the result is judged in a step 2202. If exists, in a step 2203, the battery procurement view is generated and is indicated, for example, as shown in FIG. 23. In a step 2204, selection of the battery procurement is waiting, and, in a step 2205, payment view indication processing is effected and is indicated, input of selection payment information on the payment method is waiting, and the program is ended.

In the step 2202, if No, in a step 2207, request view of S.A.T. down load is generated and is displayed as shown in FIG. 23, and, when the click operation is effected, the down load is performed from the displayed site.

Next, a plurality of battery procurement sites will be explained.

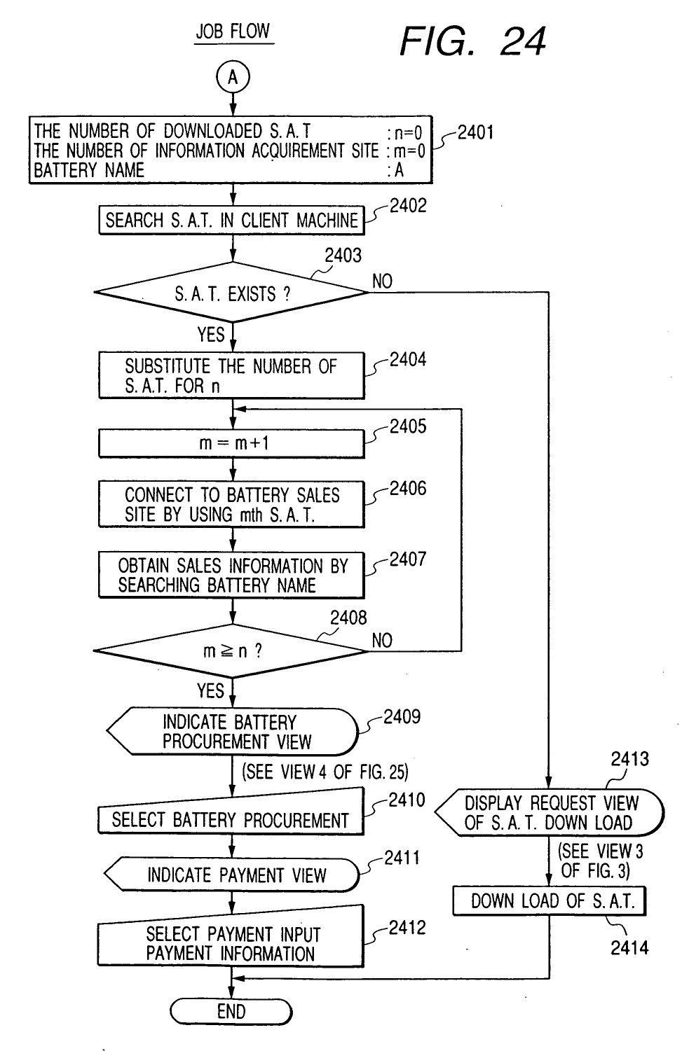

FIG. 24 shows an example that the batteries to be bought in all of S.A.T.s are searched and displayed when a plurality of S.A.T.s (site accessing tools) are exited in the user machine.

By applying this function, the user can compare the prices of the other sites and buy the site accordingly. Explanation is made with reference to the control flow shown in FIG. 24. Such a control flow is control effected on the user machine PC, and program according to the control flow is stored in a memory, and the program is carried out in a processing part, thereby effecting the control. The following steps are carried out by the processing part.

In a step 2401, parameters is set regarding the number of the down load sites, and, in a step 2402, the number of the site accessing tools on the client machine is searched. In a step 2403, if there is the site accessing tool, in a step 2404, the number of the site accessing tools is substituted for n. Then, in a step 2405, M=M+1 is executed, and, in a next step 2406, connection to a battery sales site is effected by using m-th site accessing tool, and sales information is obtained by searching A (battery name). For example, battery name, type, price and the like).

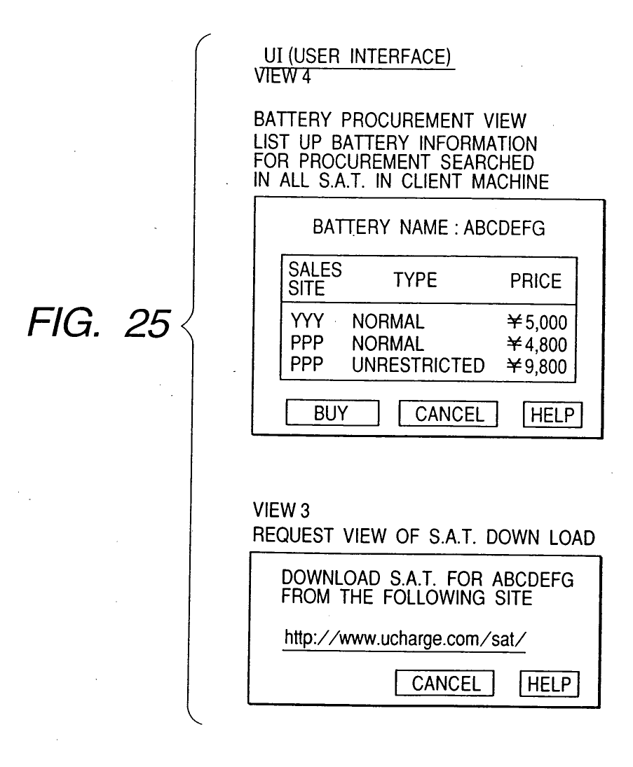

It is judged whether M is greater than or equal to N. If Yes, as shown in FIG. 25, the battery procurement view is displayed. Then, in a step 2410, the view is operated to select the battery procurement.

Then, in a step 2411, the payment view is indicated, and, in a step 2412, the selection of payment method and input of payment information are effected.

In the step 2403, if No, in a step 2413, the request view of the site accessing tool down load is generated and is displayed on the display as shown in FIG. 25.

Next, the handling regarding battery invalidation will be explained.

In the battery invalidation, the battery charge charging is effected as follows. In case of prepaid type, money obtained by subtracting predetermined cancellation commission from amount of battery unuse is paid back to the user. The amount of battery unuse is calculated from the battery remaining amount.

Incidentally, the calculation of money is effected after the supplyer collects the invalid battery from the user and the money is informed to the user. The charge in the battery invalidation can normally be applied to the unrestricted battery.

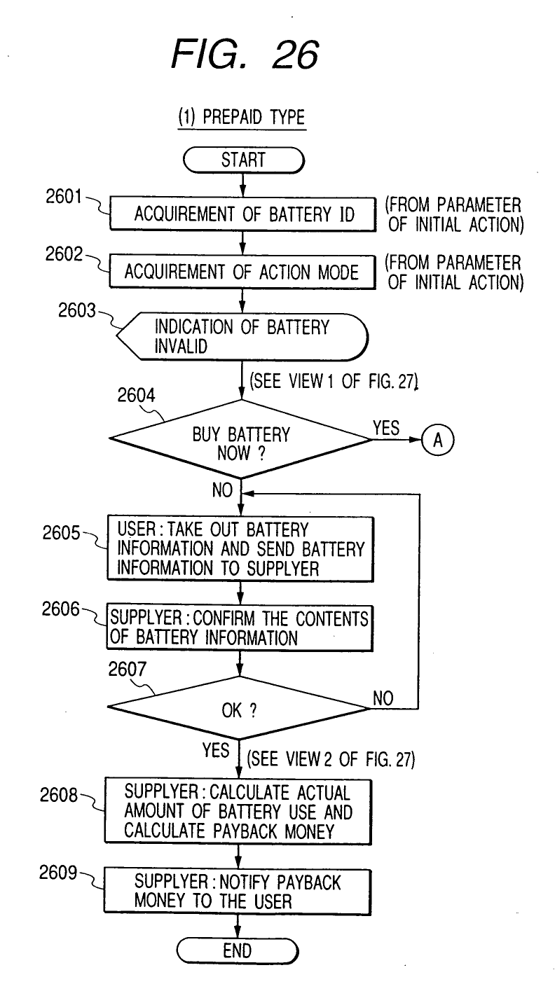

Next, explanation is made with reference to control flow shown in FIG. 26. Such a control flow is control effected on the user machine PC, and program according to the control flow is stored in a memory, and the program is carried out in a processing part, thereby effecting the control. The following steps are carried out by the processing part.

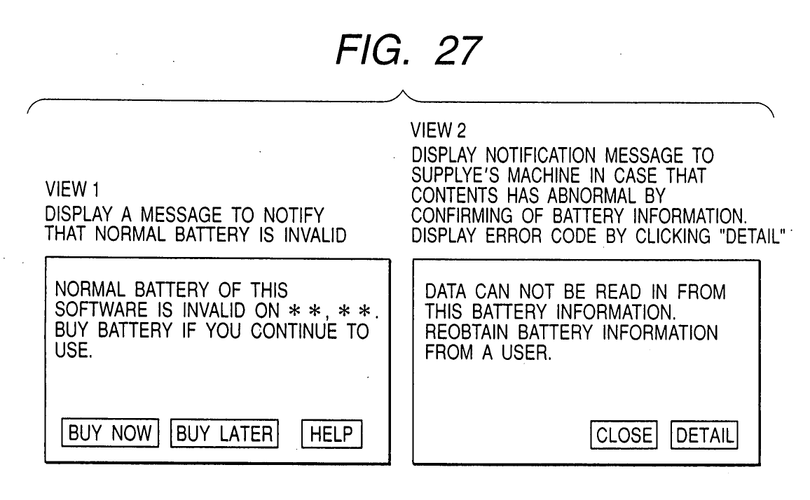

In a step 2601, the battery ID is acquired. Then, in a step 2602, the action mode is acquired. In a step 2603, the indication of battery invalid is generated and is displayed as shown in FIG. 27. Then, when “urgently buy battery” is operated, the program is transferred to the battery procurement processing in the step 2201 of FIG. 22.

If No, the battery information of user is taken out and is sent to the supplyer, and the supplyer confirms the contents of the battery, and, in a step 2607, it is judged whether the battery can be received or not. If No, the indication is made as shown in FIG. 27.

In the step 2607, if Yes, after the actual amount of battery use is calculated by the supplyer, the payback money is calculated, and, then, the payback money is informed from the supplyer to the user, and the processing is finished.

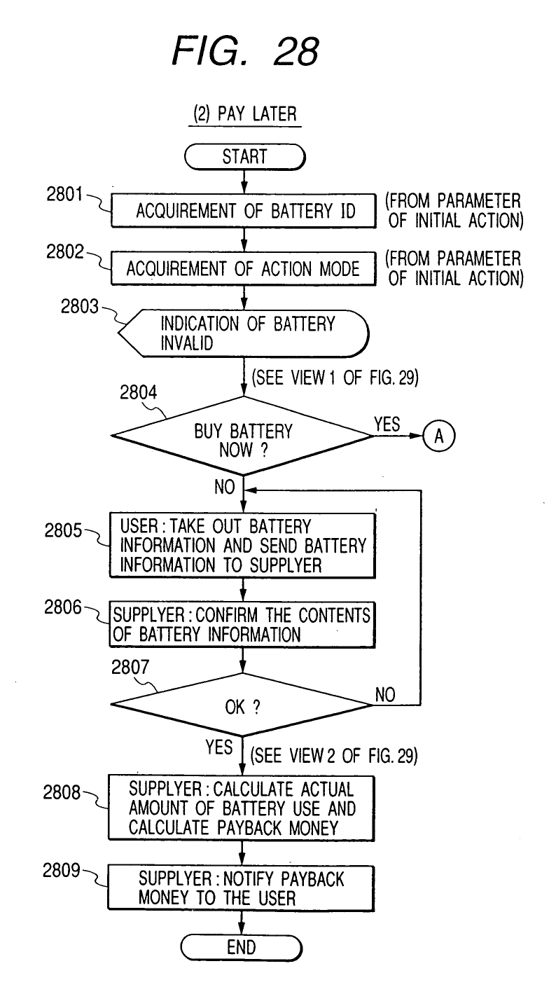

Next, explanation is made with reference to FIG. 28. Such a control flow is control effected on the user machine PC, and program according to the control flow is stored in a memory, and the program is carried out in a processing part, thereby effecting the control. The following steps are carried out by the processing part.

In a step 2801, the battery ID is acquired. Then, in a step 2802, the action mode is acquired. In a step 2803, the indication of battery invalid is generated and is displayed as shown in FIG. 27. Then, when “urgently buy battery” is operated, the program is transferred to the battery procurement processing in the step 2201 of FIG. 22.

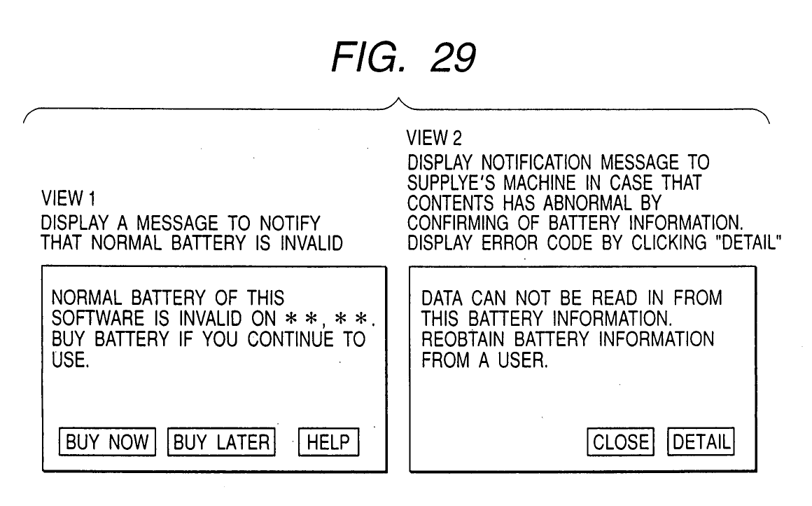

If No, the battery information of user is taken out and is sent to the supplyer, and the supplyer confirms the contents of the battery, and, in a step 2807, it is judged whether the battery can be received or not. If No, the indication is made as shown in FIG. 29.

In the step 2807, if Yes, after the actual amount of battery use is calculated by the supplyer, the charge money is calculated, and, then, the charge money is informed from the supplyer to the user, and the processing is finished.

Next, generation of the battery FD will be explained in connection with an example that such generation can be effected on the machine installed in an convenience store.

Operation will be described.

First of all, the user designates the type of the software and the payment method by using the machine installed in the convenience store.

Then, upon request of the battery, the FD is set in the terminal, and the battery is read out from the FD, and the serial number inherent to the terminal is sent from the terminal to the server. Such serial number is generated coded data, and coded battery side data is sent from the server to the terminal.

Thereafter, at the terminal side, the coded data is decoded, and after the collation between the sent serial number and the terminal specific serial number is checked, the battery data is generated.

Further, the user registration is made possible in the terminal of the convenience store. Further, when the battery is generated in the FD by using a prepaid card, secret can be reserved.

Further, a floppy disk in which only key data is written is sold in the convenience store, and on-line alteration from trial use version to product version and onerous version-up can be made.

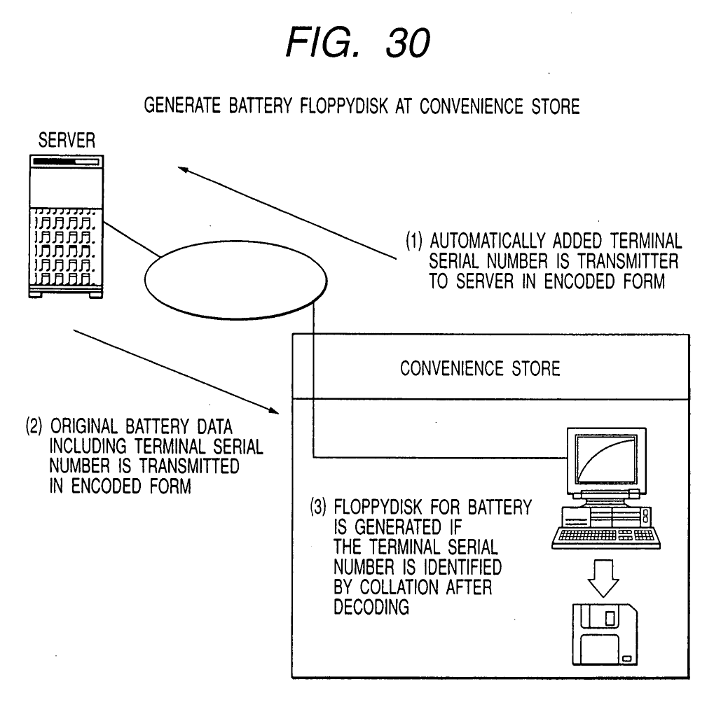

FIG. 30 is an explanatory view for achieving generation of the battery effected by the FD by using the machine installed in the convenience store. In this case, it is considered that the user machine is installed in the convenience store. Such a control flow is control effected on the host machine HM, and program according to the control flow is stored in a memory, and the program is carried out in a processing part, thereby effecting the control. The following steps are carried out by the processing part.

In FIG. 30, the server is connected to, the network. Further, the machine installed in the convenience store is also connected to the network.

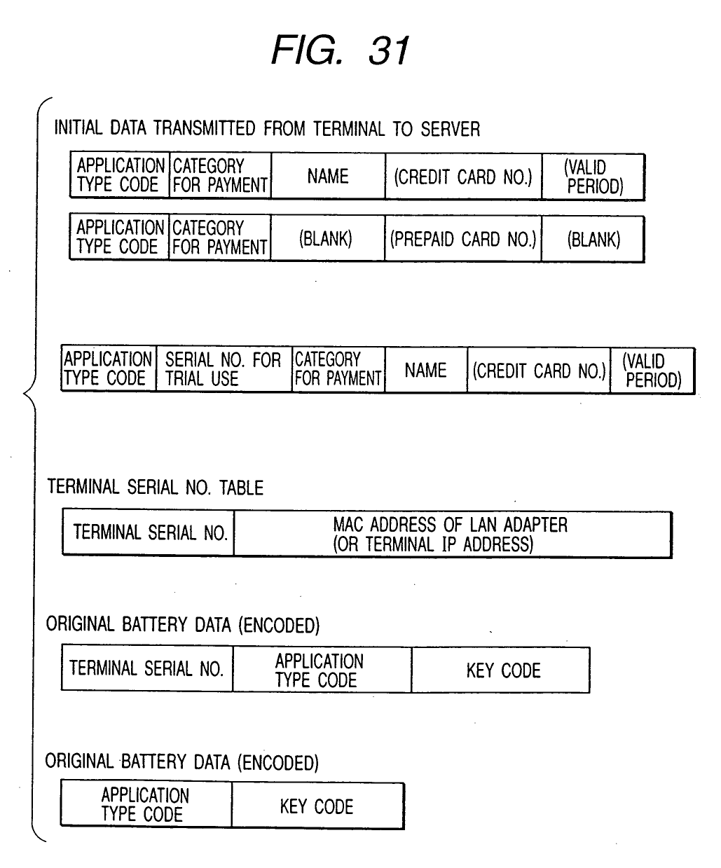

FIG. 31 shows format used in communication of data between the server and the machine. Here, the application type code comprises software type code and capacity code. The software type code means, for example, code assigned to a software article such as Word 2000 and the like, and the capacity code means code for designating the battery amount, and category for payment means code for designating payment method of a credit card, a prepaid card and the like.

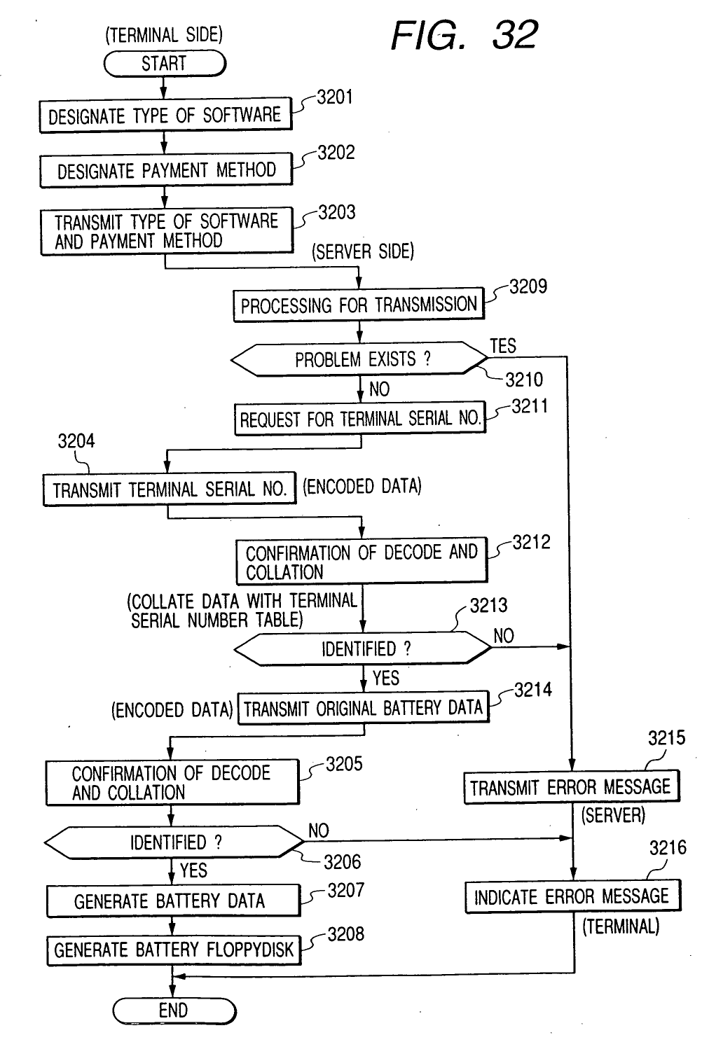

FIG. 32 is a control flow chart processed by the server and the terminal (corresponding to the user machine). Such a control flow is control effected on the user machine PC and the host machine HM, and program according to the control flow is stored in a memory, and the program is carried out in a processing part, thereby effecting the control. The following steps are carried out by the processing part.

Now, operation will be described with reference to FIG. 32.

In a step 3201, the type of software is designated from an input part of the machine. Then, the payment method is designated from the input part. The machine sends the designated type of software and payment method to the server. In a step 3209, the server effects processing transmission confirmation and requests the serial number to the machine after it is judged whether the problem exists or not. If the serial number is coded, the serial number is decoded and confirmation of collation is effected. Thereafter, the collation is confirmed and original data of the battery is sent to the machine. If necessary, the original data is coded before sending. In a step 3205, the received data is decoded and the collation is confirmed. If identified, in a step 3207, the battery data is generated, and, in a step 3208, the battery FD is generated, and the processing is finished.

In a step 3210, if the problem exists in transmission, the program goes to a step 3215, where error message is sent to cause the error message to indicate on the display of the machine.

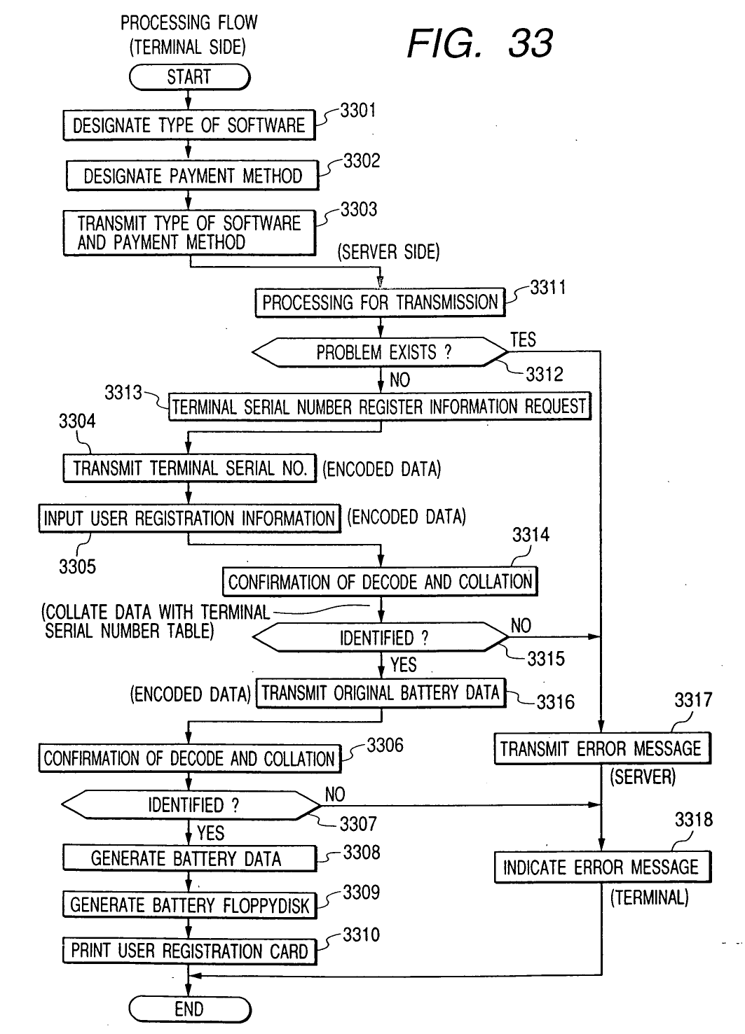

Next, control flow of register function for generating floppy disks repeatedly will be explained with reference to FIG. 33. Such a control flow is control effected on the user machine PC (corresponding to the terminal) and the host machine HM, and program according to the control flow is stored in a memory, and the program is carried out in a processing part, thereby effecting the control. The following steps are carried out by the processing part.

In a step 3301, the type of software is designated from an input part of the machine. Then, the payment method is designated from the input part. The machine sends the designated type of software and payment method to the server. In a step 3319, the server effects processing transmission confirmation and requests the serial number and register information to the machine after it is judged whether the problem exists or not. In response to such request, the machine inputs the serial number of machine and the user register information and sends them.

If the serial number is coded, the serial number is decoded and confirmation of collation is effected. Thereafter, the collation is confirmed and original data of the battery is sent to the machine. If necessary, the original data is coded before sending. In a step 3306, the received data is decoded and the collation is confirmed. If identified, in a step 3308, the battery data is generated, and, in a step 3309, the battery FD is generated, and the processing is finished.

In a step 3311, if the problem exists in transmission, the program goes to a step 3317, where error message is sent and the error message is indicated on the display of the machine.

Next, a personal common battery will be described.

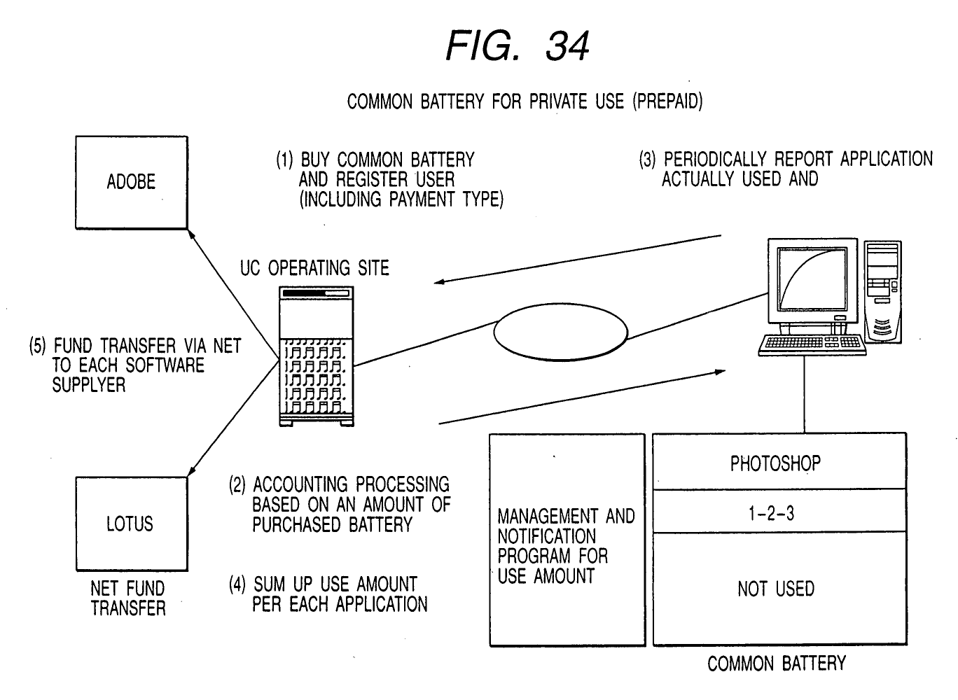

FIG. 34 is a view for explaining the personal common battery.

In such an embodiment, the user obtains the application software (trial use) from CD-ROM or network with down load. First of all,

(1) The user designates the personal information, common battery type and payment method via the input part of the machine and buys the common battery through the network (for example, inter-net). In this case, use amount management and notification program are also subjected to down load. The battery operating site effects the charge processing in accordance with the type of the common battery bought by the user. The user obtains the application software (trial use) from CD-ROM or with down load.

(2) The user designates the personal information, common battery type and payment method and buys the common battery through the inter-net. In this case, the use amount management and notification program (non-paid) are also subjected to down load.

(3) The UC operating site effects the charge processing in accordance with the type of the common battery bought by the user.

(4) The user registers the application used by himself through the inter-net. As a result, the register data is added to a server of the UC operating site. In this case, the application registered by the user is added to the common battery by the use amount management and notification program, thereby making the application usable.

(5) The used application and function used in the application are recorded in the user machine PC, and the remaining amount of the battery is decreased in accordance with the used functions.

(6) The use results of the applications are automatically totalized periodically, and the total is sent to the UC operating site.

(7) The UC operating site totalizes the use result of each application to calculate use result of each application. In accordance with the use result of each application, money obtained by subtracting predetermined commission is paid to each software maker.

(8) The user can effect interruption of use of registered application and additional registration of new application. When the use of the application is interrupted, the use results of the interrupted application are totalized and the total is sent to the UC operating site.

(9) The use amount management and notification program (non-paid) are included in the application (included in the CD-ROM or the down load file).

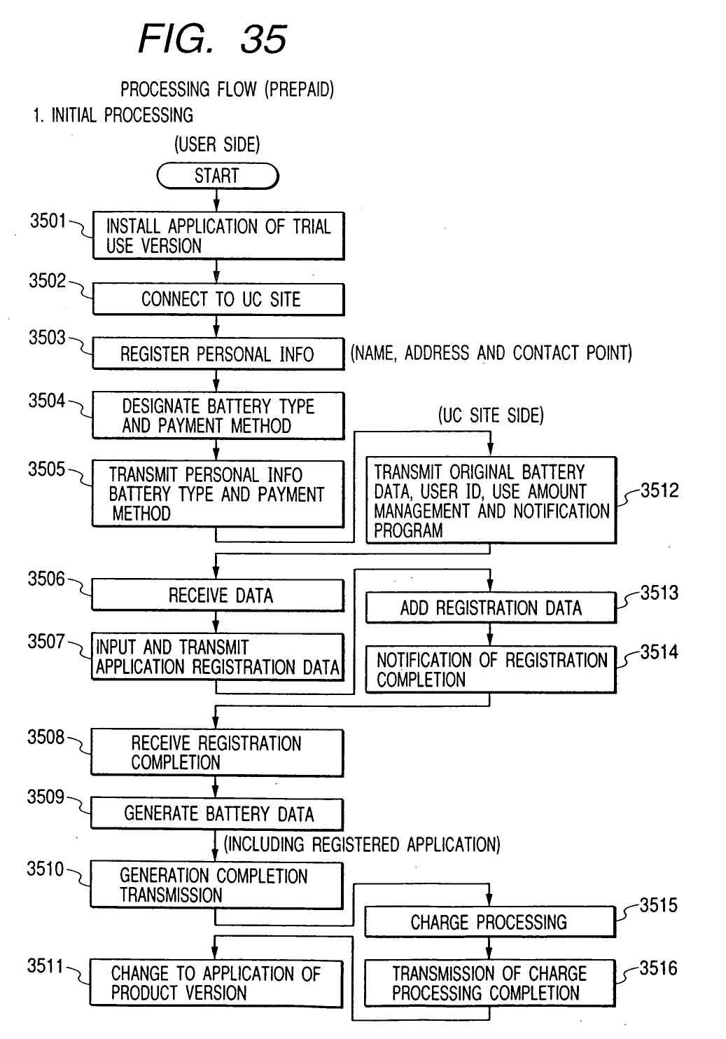

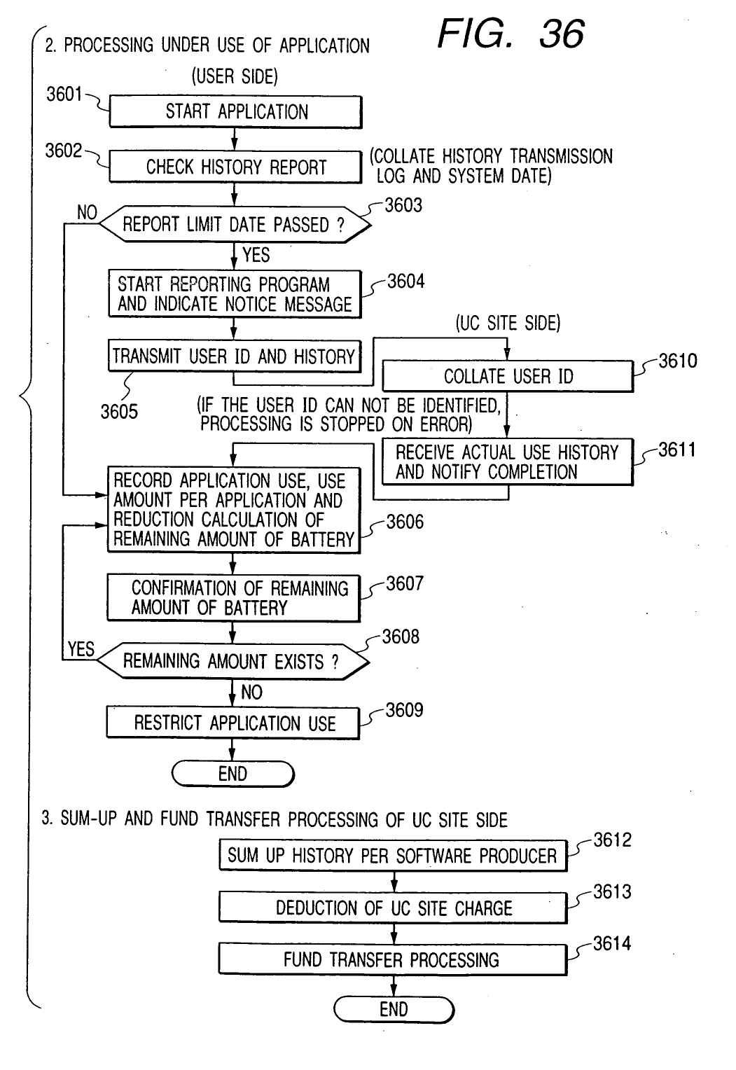

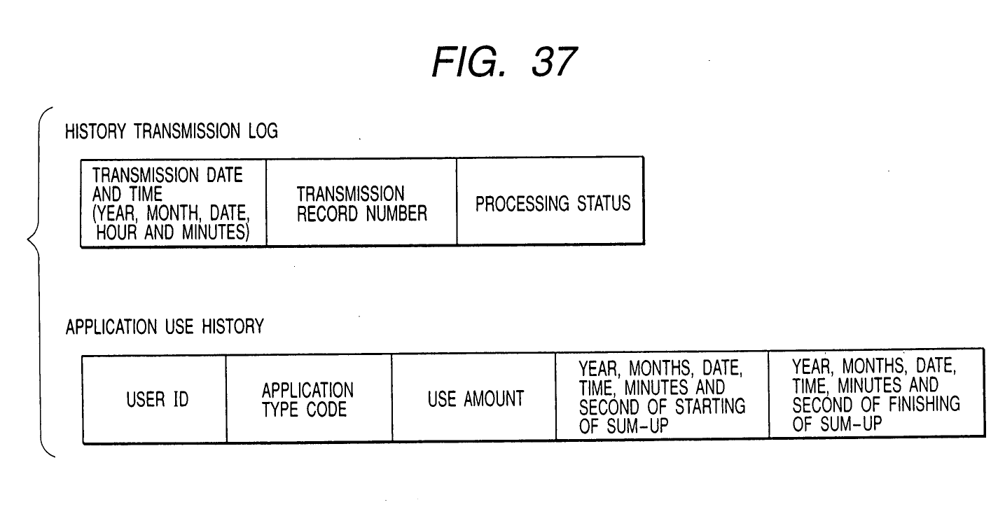

Next, further explanation is made with reference to FIGS. 35 and 36. Such a control flow is control effected on the user machine PC (corresponding to the terminal) and the host machine HM (corresponding to the server), and program according to the control flow is stored in a memory, and the program is carried out in a processing part, thereby effecting the control. The following steps are carried out by the processing part.

In a step 3501, the application is installed in the machine. Then, a connection to a site supplying the battery is effected. After the connection, in a step 3503, the personal information is registered in the site.

In a next step 3504, the type of the battery and payment method are designated. Then, the designated data is sent. Namely, in a step 3505, data regarding the personal information, type of the battery and payment method is sent to the site. When the sent date is received, the site sends original battery data, user ID, use amount management and notification program to the machine.

At the machine side, when the sent date is received, application registration data is inputted and it is sent to the site. On the other hand, at the site side, in a step 3513, registration date is added and registration completion is informed to the machine. At the machine side, in a step 3508, the registration completion is received, and the battery data is generated. After the generation, generation completion is informed to the site. At the site side, upon receipt of the generation completion, the charge processing is effected, and charge processing completion is transmitted. At the machine side, upon receipt of the charge processing completion, the software of trial version is changed to the software of product version, and the processing is finished.

Next, consumption control of battery when the application software is used will be explained with reference to FIG. 36. Such a control flow is control effected on the user machine PC (corresponding to the terminal) and the host machine HM (corresponding to the server), and program according to the control flow is stored in a memory, and the program is carried out in a processing part, thereby effecting the control. The following steps are carried but by the processing part.

When the user starts the application, check for history report is effected, and collation between history transmission log and system date is effected. Then, it is judged whether report limit date is passed or not. If No, in a step 3606, application use and use amount per application are recorded, and reduction calculation of the remaining amount of the battery is effected. Then, the remaining amount of the battery is confirmed, and it is checked whether the remaining amount exists or not. If there is the remaining amount, the reduction calculation of the remaining amount is effected repeatedly. If the remaining amount does not exist, in a step 3609, restriction of application use is effected, and the processing is finished.

In a step 3603, if the report limit date is passed, in a step 3604, reporting program for generating notice message and for indicating it on the display is started, and the user ID and history report are transmitted.

The site side collates the user ID and receives the history and notifies completion. Thereafter, the program goes to a step 3606.

Next, sum-up and fund transfer processing of the UC site side will be explained.

In a step 3612, sum-up of history per software producer is effected. Then, deduction of the UC site charge is effected, and the fund transfer processing is effected, and the processing is finished.

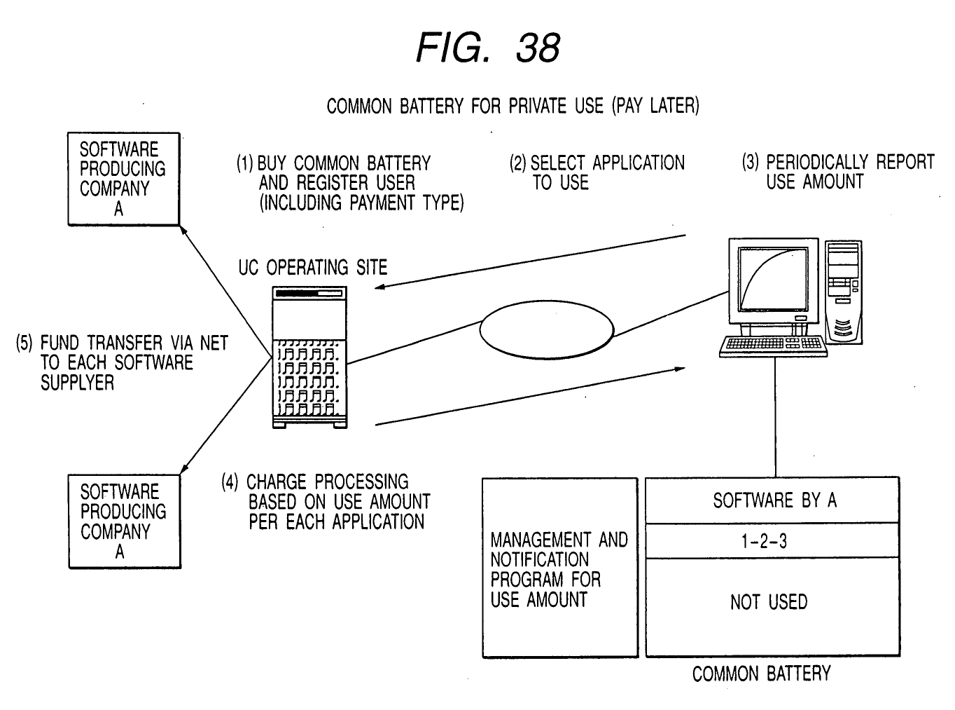

Next, another embodiment of the personal common battery will be described with reference to FIG. 38.

In a pay later type.

(1) The user obtains the application software (trail use) from CD-ROM or with down load.

(2) The user designates the personal information, common battery type and payment method and buys the common battery through the inter-net. In this case, the user amount management and notification program (non-paid) are also subjected to down load.

(3) The user registers the application used by himself through the inter-net. As a result, the register data is added to a server of the UC operating site. In this case, the application registered by the user is recorded in the common battery by the use amount management and notification program.

(4) The battery data is generated, thereby making the application usable.

(5) The used application and function used in the application are recorded in the user machine PC, and the remaining amount of the battery is decreased in accordance with the used functions.

(6) The use results of the applications are automatically totalized periodically, and the total is sent to the UC operating site.

(7) The UC operating site totalizes the use result of each application sent from each user to calculate use result of each application.

(8) On the basis of the use result of each application, the charge processing to the users is effected.

(9) In accordance with the use result of each application, money obtained by subtracting predetermined commission is paid (fund transfer) to each software maker.

(10) The user can effect interruption of use of registered application and additional registration of new application. When the use of the application is interrupted, the use results of the interrupted application are totalized and the total is sent to the UC operating site.

(11) The use amount management and notification program (non-paid) are included in the application (included in the CD-ROM or the down load file).

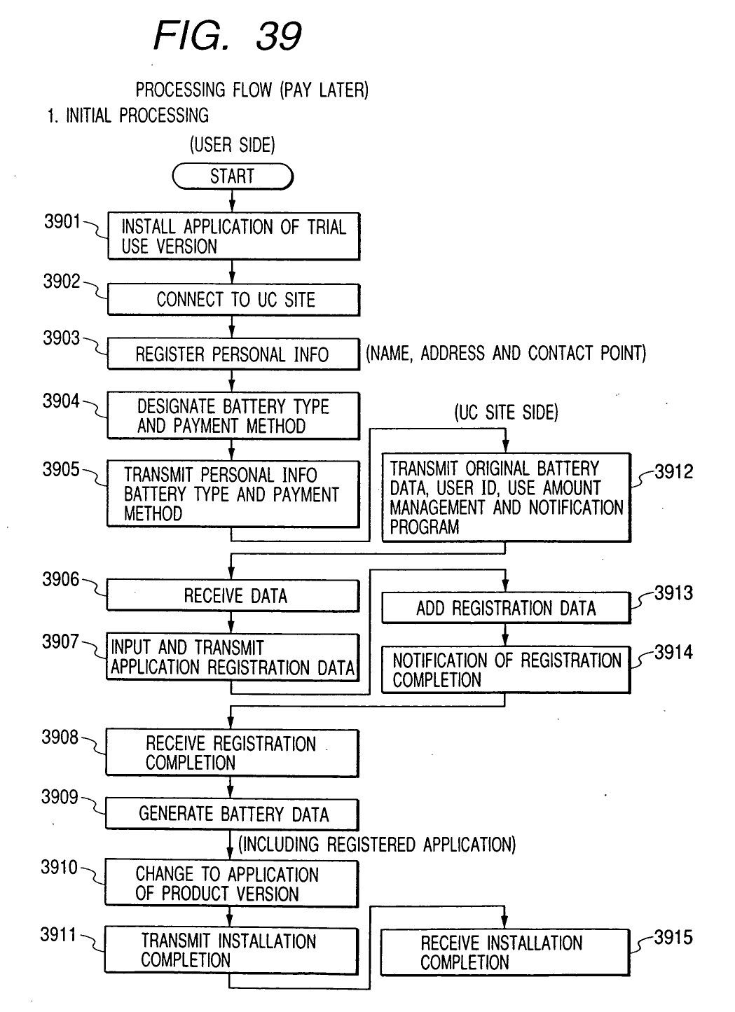

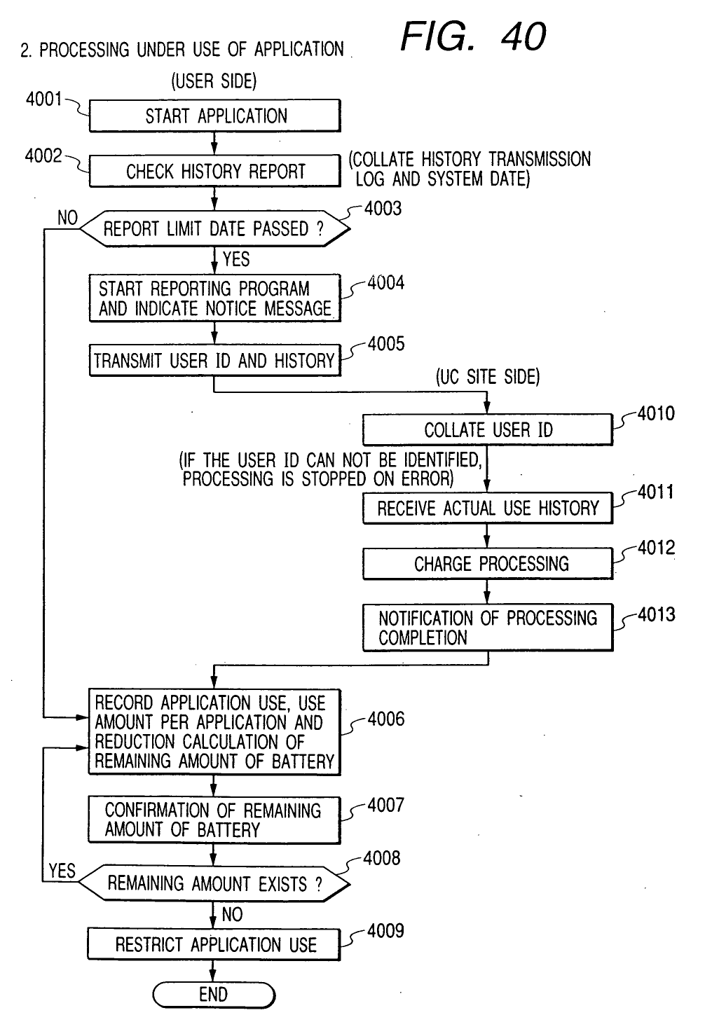

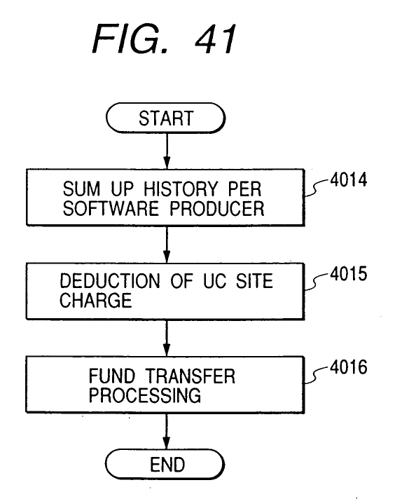

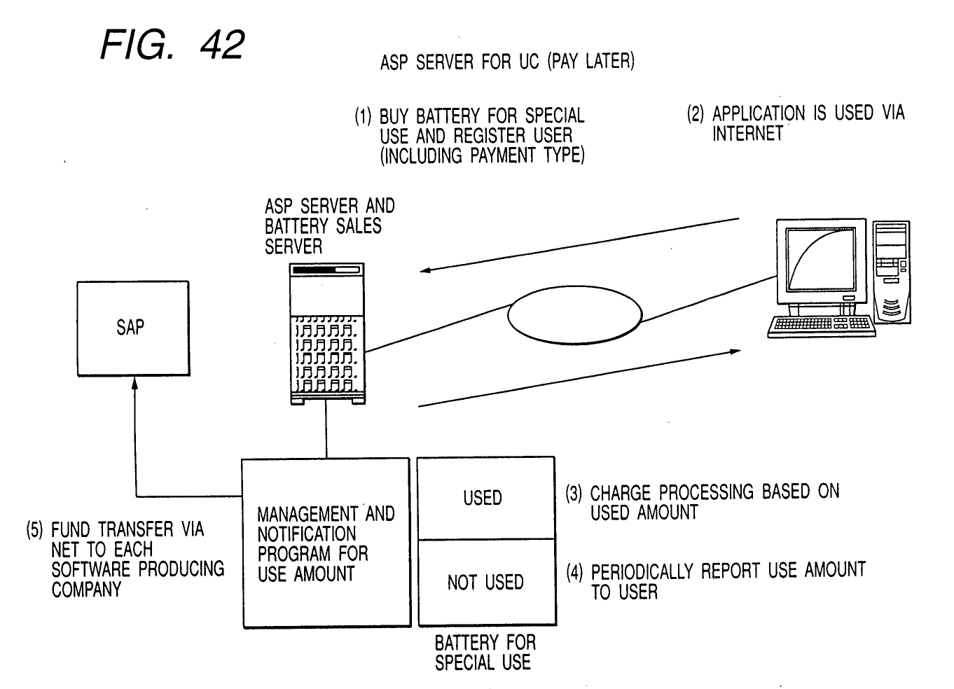

The above-mentioned operation will be explained with reference to FIGS. 39 to 41.

Regarding control flow shown in FIG. 39, such a control flow is control effected on the user machine PC (corresponding to the terminal) and the host machine HM (corresponding to the server), and program according to the control flow is stored in a memory, and the program is carried out in a processing part, thereby effecting the control. The following steps are carried out by the processing part.

In a step 3901, the application is installed in the machine. Then, a connection to the battery site is effected. After the connection, the personal information is registered. Then, the type of the battery and payment method are designated. The personal information, type of the battery and payment method inputted in the above step are sent to the site. At the battery site, in a step 3905, when the sent date is received, original battery data, user ID, use amount management and notification program are sent. The user machine receives such date and inputs the application registration data and sends it to the batter site. At the battery site, the data is received and is registered as additional data (registration data). Then, registration completion is sent to the machine. At the machine side, after the registration completion is received in a step 3908, the battery is generated, and, thereafter, the application installed in the machine is changed from the trial use version to the product version, and installation completion is sent to the battery site. The battery site receives the installation completion.

Next, control flow when the application installed in the machine as mentioned above is carried out will be explained. Such a control flow is control effected on the user machine PC (corresponding to the terminal) and the host machine HM (corresponding to the server), and program according to the control flow is stored in a memory, and the program is carried out in a processing part, thereby effecting the control. The following steps are carried out by the processing part.

In a step 4001, the application is started. Then, the history report is checked. By checking the result, it is judged whether report limit date is passed or not.

If No, application use and use amount per application are recorded, and reduction calculation of the remaining amount of the battery is effected. Then, the remaining amount of the battery is checked. If there is the remaining amount, the program is returned to a step 4006 again, where the same processing is repeated. If the remaining amount does not exist, since limit of application use is reached, the program is ended.

In a step 3603, if Yes, in a step 4004, reporting program for indicating notice message is started, and the user ID and history report are transmitted. The site side collates the user ID and receives the history data. Then, the charge processing is effected. Processing completion is informed to the machine, and the program goes to the step 4006.

The site further effects sum-up of the history per software producer, deduction of commission of the battery site and fund transfer processing, and the program is ended.

Next, another embodiment when the application on the server is used will be explained.

As initial processing,

(1) The user perform a connection to the UC corresponding ASP site;

(2) The user registers company information (company name, address, telephone number and the like);

(3) The user designates use application, use battery, payment method and pass-word;

(4) Input information is sent to the server;

(5) At the ASP server side, user registration, generation of user account and transmission of user ID are effected; and

(6) The user receives the user ID sent from the ASP server.

As processing during the use,

(1) The user sends the user ID and pass-word;

(2) At the ASP server side, authentication processing is effected;

(3) The user designates the application, and the processing is started;

(4) At the ASP server side, the processing is executed, and use history is added in accordance with functions used by the user;

(5) When the closing time for the used amount is reached, at the ASP server side, the use history is totalized and the charge processing is carried out; and

(6) The used amount and charge money are reported to the user periodically.

As the fund transfer processing to the software producers,

(1) The use history per software producer is totalized on the basis of the use history per user; and

(2) The use history per software producer is converted into money base, and fund transfer processing with deduction of predetermined commission is effected.

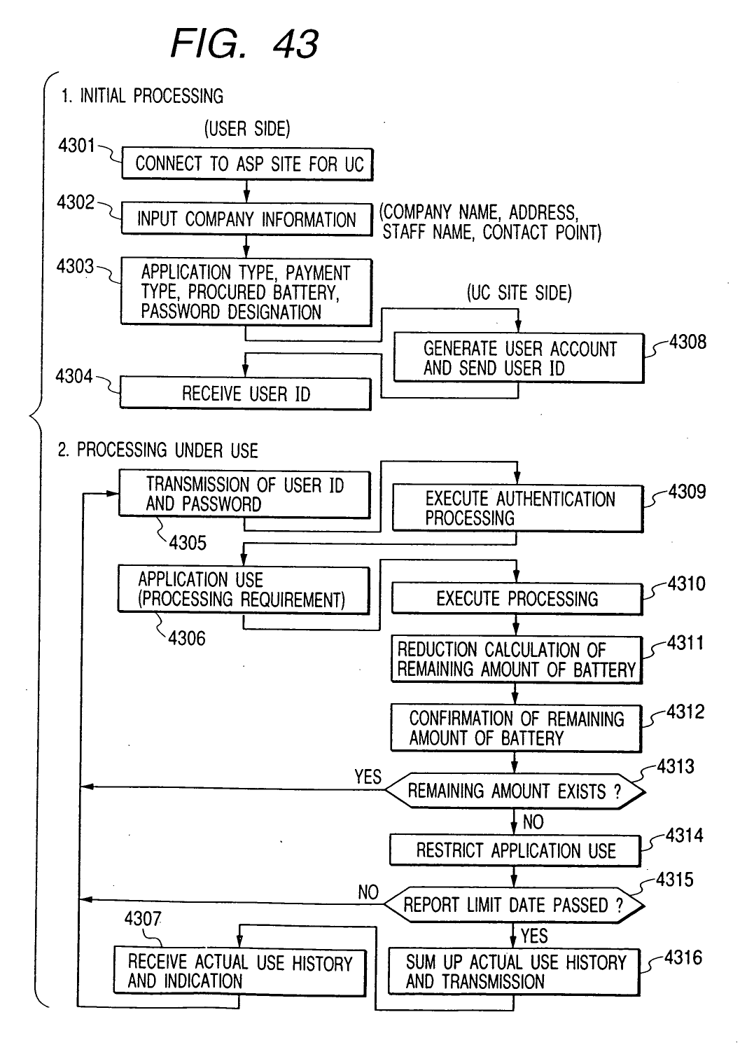

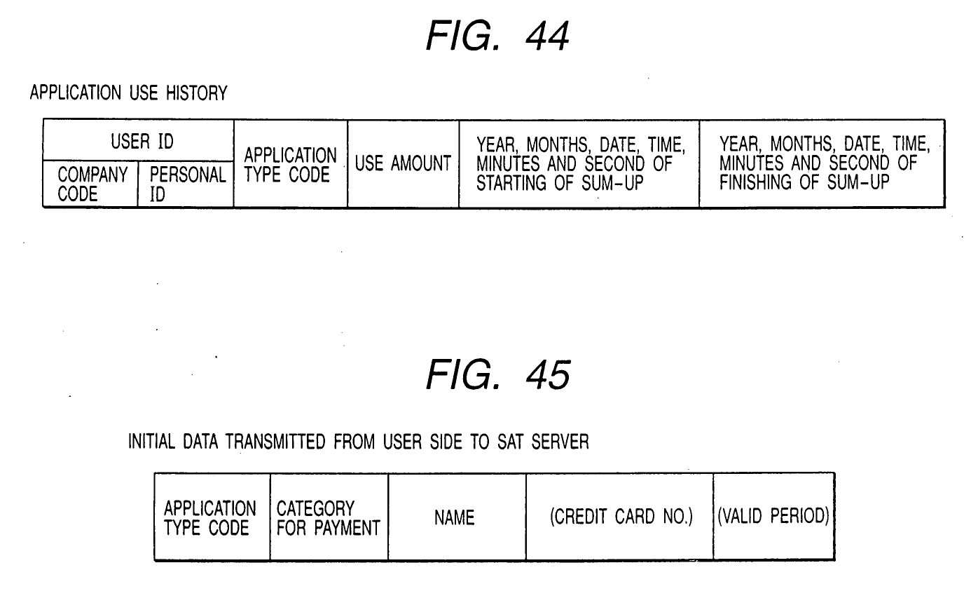

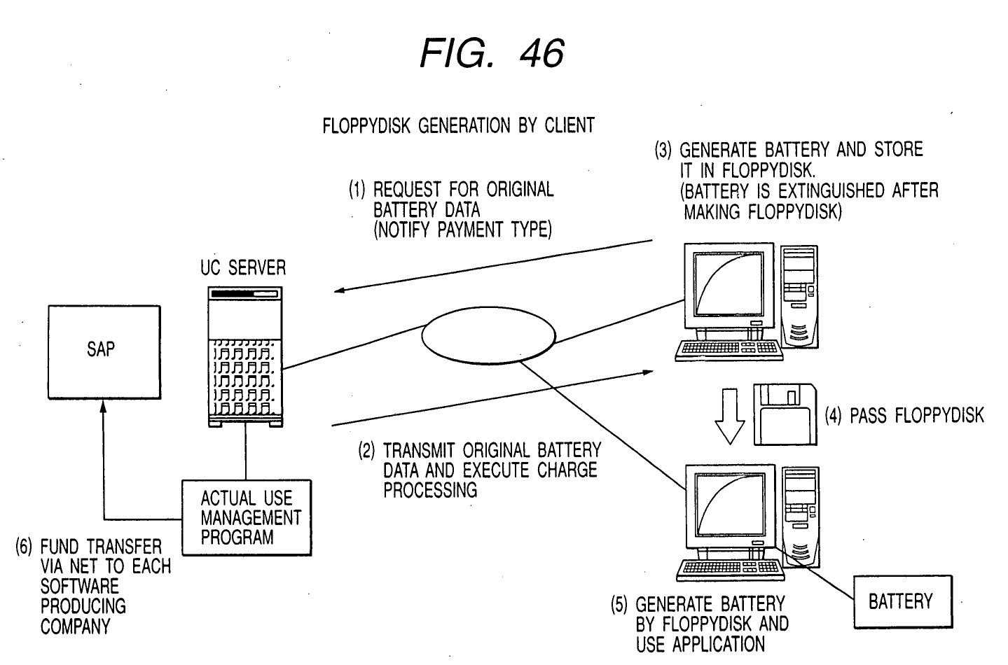

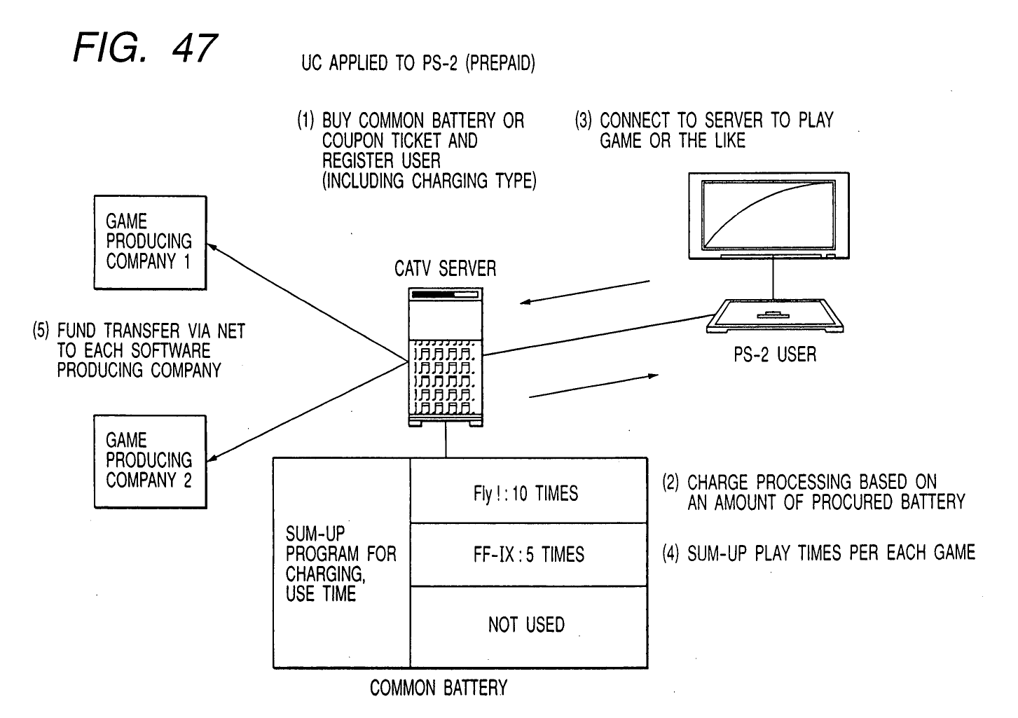

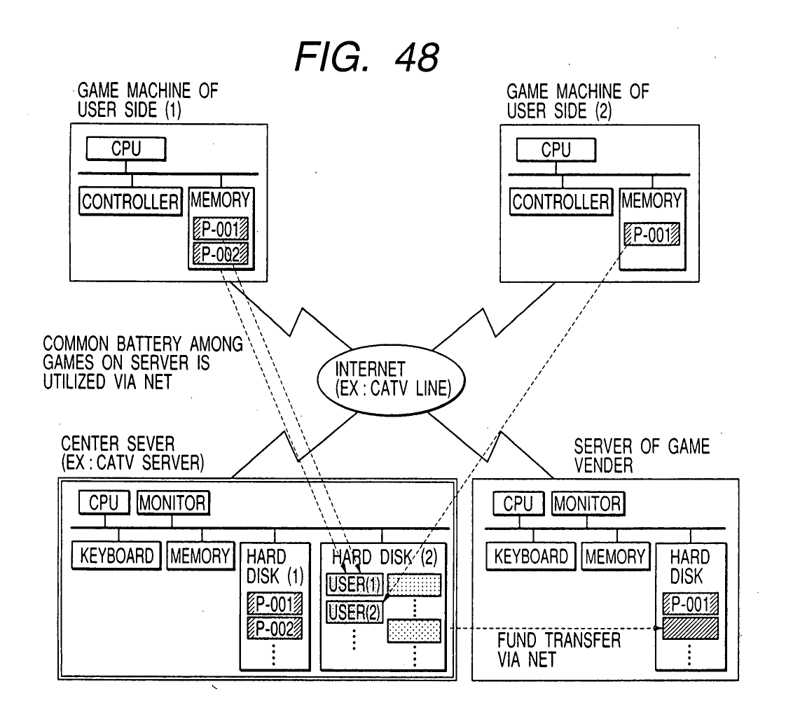

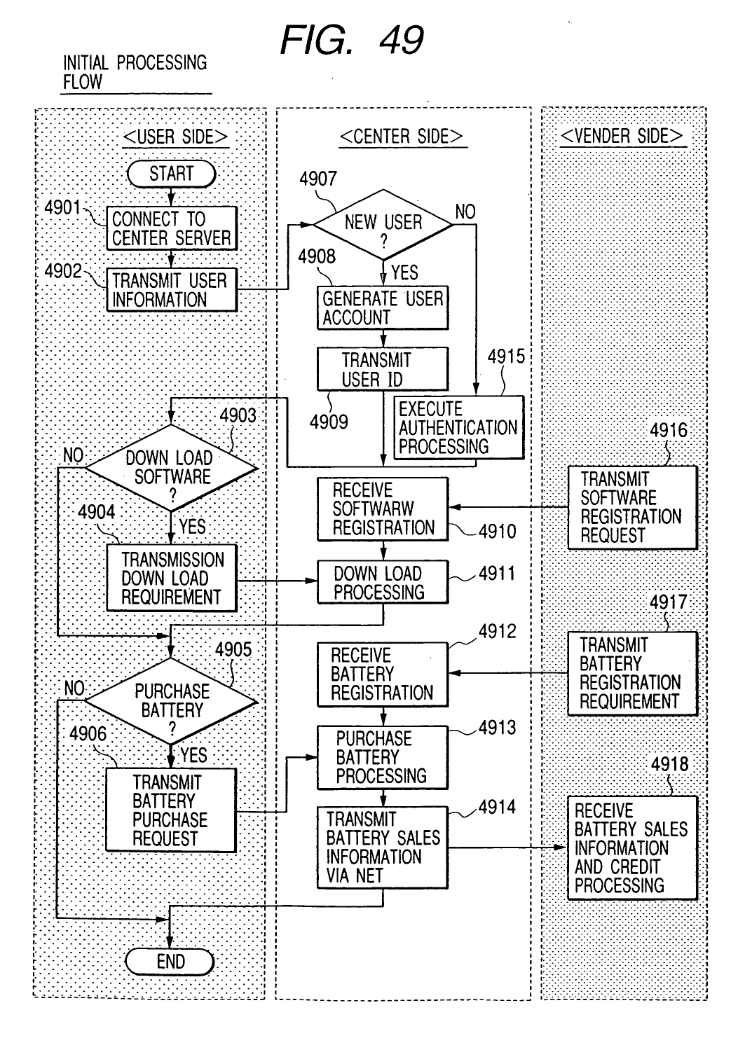

The above-mentioned operation will be explained with reference to FIGS. 43 to 45.

Regarding control flow shown in FIG. 43, such a control flow is control effected on the user machine PC (corresponding to the terminal) and the host machine HM (corresponding to the server), and program according to the control flow is stored in a memory, and the program is carried out in a processing part, thereby effecting the control. The following steps are carried out by the processing part.

In a step 4301, a connection to the site is effected. Then, the company information is inputted. Then, application type, payment method, procured battery and pass-word are inputted. When such input data is received by the site, in a step 4308, at the site side, the user account is generated and the user ID is generated, and they are transmitted. At the machine side, in a step 4304, the ID is received.

Next, control flow during the use will be explained. Such a control flow is control effected on the user machine PC (corresponding to the terminal) and host machine HM (corresponding to the server), and program according to the control flow is stored in a memory, and the program is carried out in a processing part, thereby effecting the control. The following steps are carried out by the processing part.

In a step 4305, the user ID and pass-word are transmitted. At the site side, authentication processing is effected. The application is used. At the site side, the processing is executed. Then, reduction calculation of the battery remaining amount is effected. Then, the remaining amount of the battery is confirmed. If there is the remaining amount, the program is returned to the step 4306. If there is no remaining amount, restriction of application use is effected, and, it is judged whether the report limit date is passed. If Yes, the sum-up of actual use history is effected and the result is transmitted. To the contrary, at the machine side, the received data is indicated on the display, and the program is returned to the step 4306 (application use step). If otherwise, the application use in the step 4306 is continued.

As a method for generating the battery on the user machine PC (method for generate the battery FD on the client machine PC side to cause other clients to use such battery ID (prepaid)),

(1) The user effects a connection to the UC server and designates the type of software and payment method;

(2) The UC server sends the original battery data to the user machine PC;

(3) At the user machine PC side, the battery data is generated and the battery FD is generated, and, then, the battery data is automatically deleted;

(4) A third person who received the battery FD generated uses the application in the battery FD;

(5) The remaining amount of the battery is decreased as the third person uses the application; The UC site totalizes the use history per application sent from the user and calculates the use history per application; In accordance with the use history per application, fund transfer processing with deduction of predetermined commission is effected to each software producer;

(6) The battery generation data includes coded request number and coded battery ID, so that, if a battery tries to be generated on the basis of the same request number and the same battery ID, error will occur; and

(7) A part of the generated battery (after format for special use) is charged to the FD, and the difference is discharged from the client's battery (flexibility to other clients).

Next, an application in which the battery software is used with a game machine will be explained.
A single battery (as imaginary composite battery divided for plural users) is prepared on the server, or a plurality of batteries for respective users are prepared.
The battery is prepared on the server through CATV circuit always connected, so that use is permitted for only predetermined number in a coupon manner (for example, a coupon ticket capable of playing up to 50, times can be bought).
The battery data is recorded and registered in an auxiliary storage medium such as memory stick.
Weighting of two tickets for one play can be set in network competition.
A battery for special use for specific game or a common battery may be used.

As file items, for example, the following items are set:

<Game Software Information>

software name
battery ID
price
vender name
   <Battery Information Per User>
user ID
battery name
battery procurement date
battery type (exclusive/common)
battery amount
log information→managed in other DB
remaining ticket number
today's date
today's play starting time
today's play finishing time
today's play number
today's play time
MAX play number/day
MAX play time/day

Processing items:

(Vender) Registration of Game Software

UC corresponding game software is registered in a center (server on the inter-net). The registered information can always be inspected from a NonPC machine of user.

(User) Down Load of Game

The NonPC machine connected to the inter-net is connected to the center, and game to be played is down-loaded from the registered list.

(User) Ticket Procurement

The ticket for the game to be played is procured. Upon procurement, restriction of use number and use time can be added to the ticket.

(Center) Ticket Procurement Fee Fund Transfer

The center collects the ticket procurement fee and the fund transfer of the fee is effected through the inter-net.

(User) Play Start

At a time when the user starts the game, the connection to the center is effected, and, the ticket number required for playing said game is subtracted from “remaining ticket number” of the battery information, and the play starting time is recorded in “today's play starting time”. When the restricted ticket is utilized, the user plays the game under the following various restrictions:

(1) Play Time Restriction

At a time when “today's play time” becomes equal to “MAX play time”, use completion is noticed to the NonPC of the user from the center (server). The notice can be indicated as “last XX minutes”.

(2) Play Number Restriction

Under playing, when a predetermined check point-is passed (for example, first stage clear), “1” is added to “today's play number” of the battery information. At a time when “today's play number” becomes equal to “MAX play number”, use completion is noticed to the NonPC of the user from the center (server). The notice can be indicated as “last XX number”.→Number restriction.

(User) Play Finish

At a time when the user finishes the game, the connection to the center is effected, and, the finishing time is recorded in “today's play finishing time” of the battery information.

(Objects and Advantages)

Since almost all of mechanisms are included in the center (server), the client may merely install the UC corresponding game software;

Upon procurement of ticket (battery), the restricted conditions can be added;

Child's game use can be restricted; and

The weighting of ticket can be set to discriminate between games.

The ticket (battery) can be made common.

The above objects will now be fully explained.

FIG. 49 is a flow chart showing initial processing. Such a control flow is control effected on the user machine PC (corresponding to the terminal) and the host machine HM (corresponding to the server), and program according to the control flow is stored in a memory, and the program is carried out in a processing part, thereby effecting the control. The following steps are carried out by the processing part.

In FIG. 49, first of all, in a step 4901, a connection to the server of the center is effected. Then, the user information is transmitted to the center. At the center side, in a step 4907, it is checked whether the user is a new user or not. If No, the authentication processing is executed, and the program is shifted to a step 4903 of the user machine. At the machine side, it is checked whether the software should be subjected to down load or not. If Yes, down load requirement is transmitted. At the center side, upon receipt the down load requirement, down load processing is effected. As a result, at the user machine side, it is checked whether the battery is purchased or not. If Yes, in a step 4906, battery purchase request is transmitted to the server. At the center side, in a step 4913, battery purchase processing is effected, and then, the payment processing is effected via battery sales information transmission network. And, at the vender machine side, upon receipt of the payment processing, credit processing is effected.

In the step 4907, if the new user exists, the user account is generated and the user ID is transmitted, and the program goes to the step 4903.

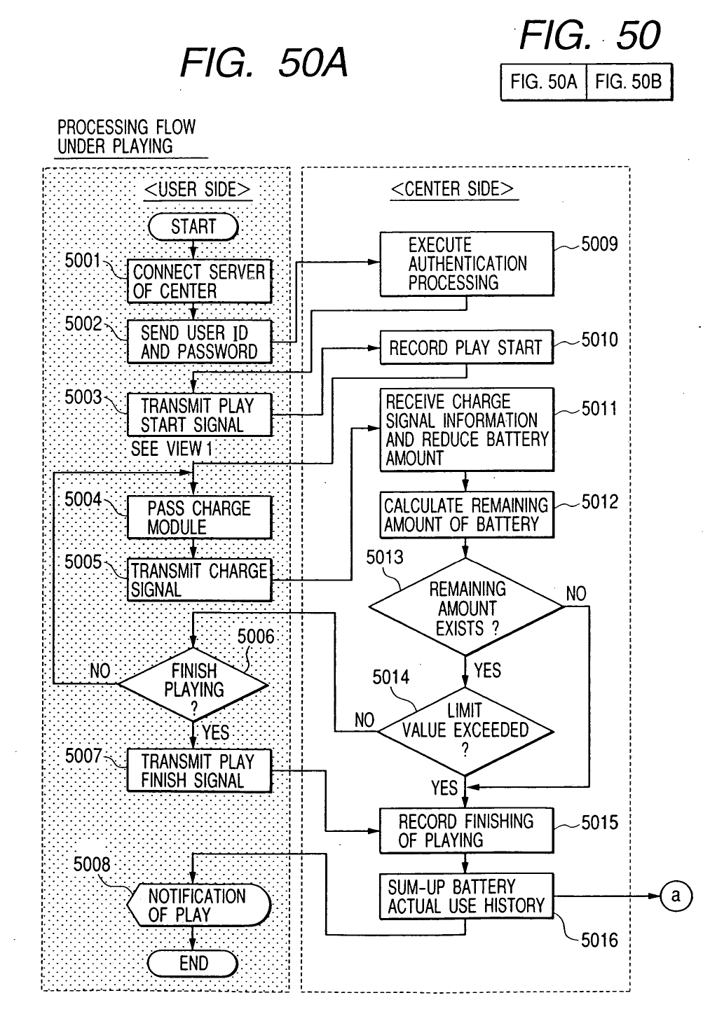

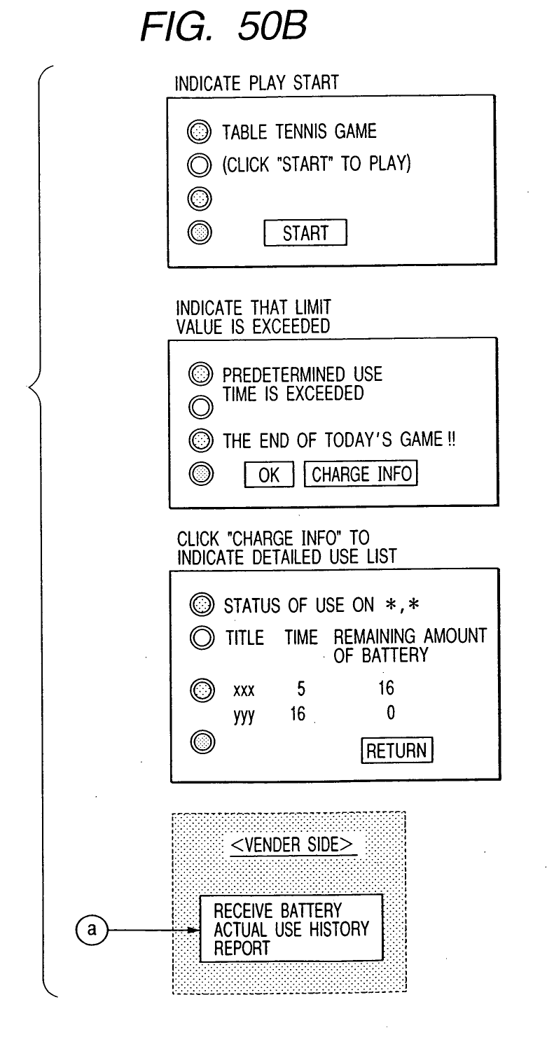

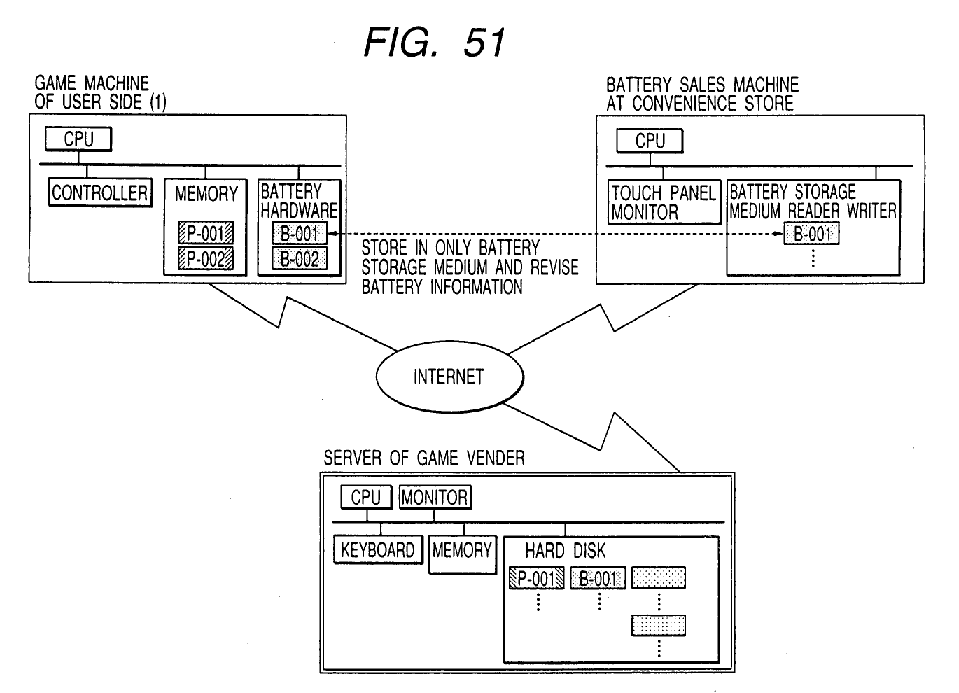

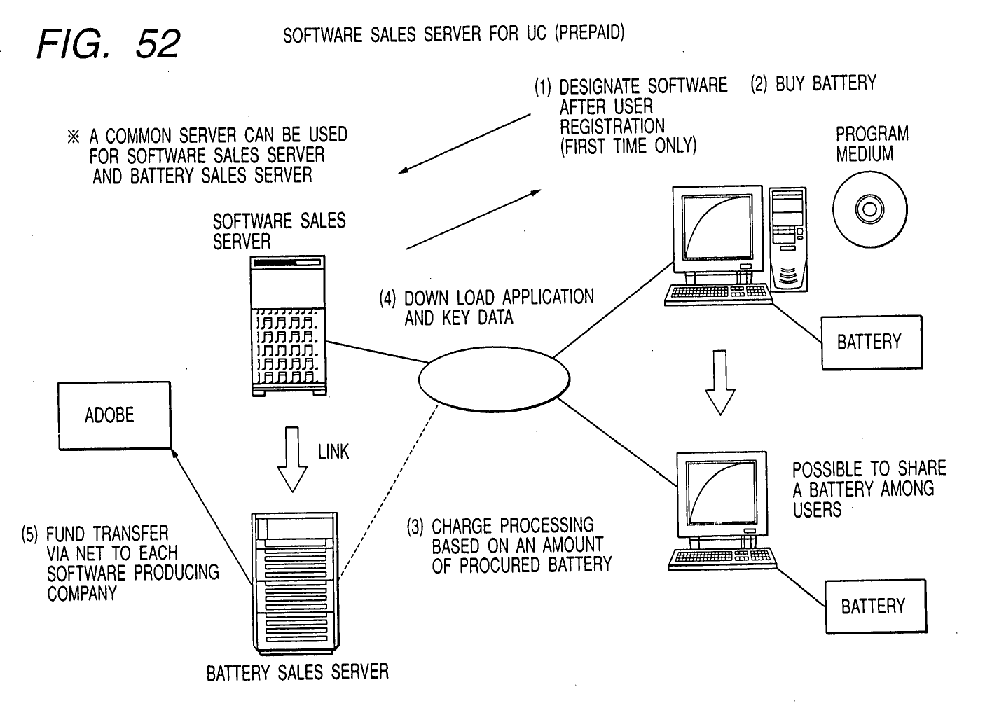

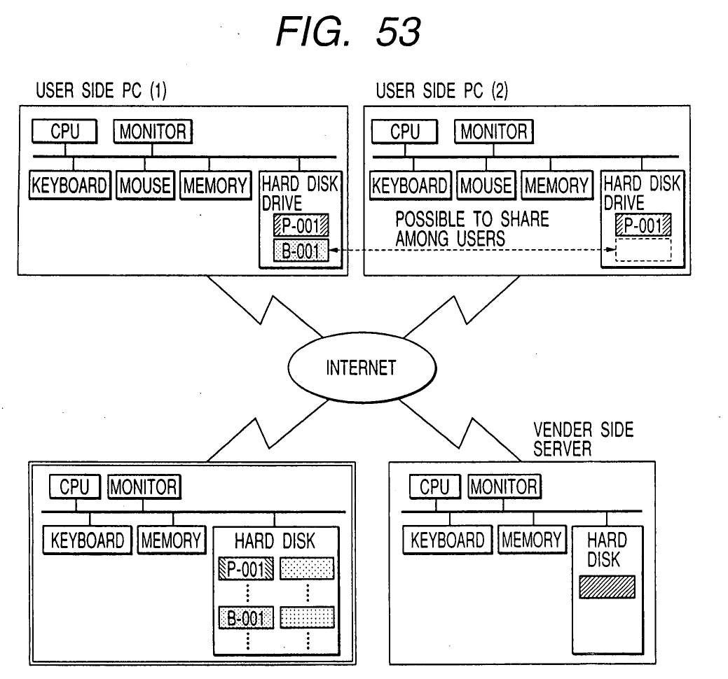

Next, an operation effected when the software is executed after the above-mentioned initial processing will be explained. In FIG. 50A, in a step 5001, a connection to the server of the center is effected. Then, in a step 5002, the user ID and pass-word are transmitted. At the center server side, in a step 5009, authentication processing is executed, and, in a step 5003, at the user side, a play start signal is transmitted. In a step 5010, the signal is received by the server, and the play start is recorded. After the recording, the charge processing is started in a step 5004, and, in a step 5005, a charge signal is sent from the machine side to the server side, and, in a step 5011, at the server of the center side, the processing for decreasing the battery amount is effected. In a next step 5012, the remaining amount of the battery is calculated. In a step 5013, if there is the remaining amount, in a step 5014, it is checked whether the limit value is exceeded or not. If No, it is checked whether the play is finished or not. If No, the program is returned to the step 5004, where the charge processing is continued. In the step 5006, if the play is finished, the play finish signal is transmitted from the machine side to the server side, and in a step 5015, finishing of play is recorded, and then, sum-up of actual battery use history is effected, and the result is noticed to the vender, and, at the vender side, actual battery use history report is received. Further, after the sum-up, in a step 5008, notification of play finishing is displayed at the machine side and the charge information is also displayed.

In the step 5014, if the limit value is exceeded, in the step 5015, finishing of play is recorded, and, thereafter, the same processing as mentioned above is effected.

Next, a software distribution server and a battery sales server will be described.

The software and the battery program registered on the server of the inter-net is down-loaded by the user (client). Further, an embodiment in which, by purchasing, by the user, the battery suitable for his application, the battery can be used on his local machine PC will be explained.

The software use of which is controlled by the battery is started by combining with the battery.

The software controlled by the battery is copy-free.

For example, the battery is generated at the client side by sending the battery information to the client side, rather than by effecting down load of file.

A connection to the software (controlled by the battery) distribution server and battery sales server is effected.

User registration (including input of payment method) is effected.

The software controlled by the battery used is designated, and the down load is effected (down load of the software controlled by the battery into which the test battery information was previously incorporated is also possible).

The type (test/normal/unrestricted) of the battery to be used is designated.

On the basis of the designated battery type, the battery information is sent from the server to the client. The battery is generated at the client side.

The battery sales information is sent to the servers of respective software venders.

The battery fee collected from the user is paid to the vender via the inter-net.

With the above-mentioned arrangement, the following matters can be realized:
The combination of the software controlled by the battery and the battery can be applied to the conventional test version and product version;
Flexibility of the battery between users is permitted; and
The battery purchasing fee can be paid to the vender via the net.

Next, a UC corresponding software sales server (prepaid) will be described.

Various software are prepared on the server of the inter-net. Each client effects down load of test version software from the server (CD-ROM or DVD-ROM storing various software may be purchased and only key data may be subjected to down load).

By obtaining or purchasing the battery from a link of the server, the product version can be used as it is.

There is flexibility of battery between the clients.

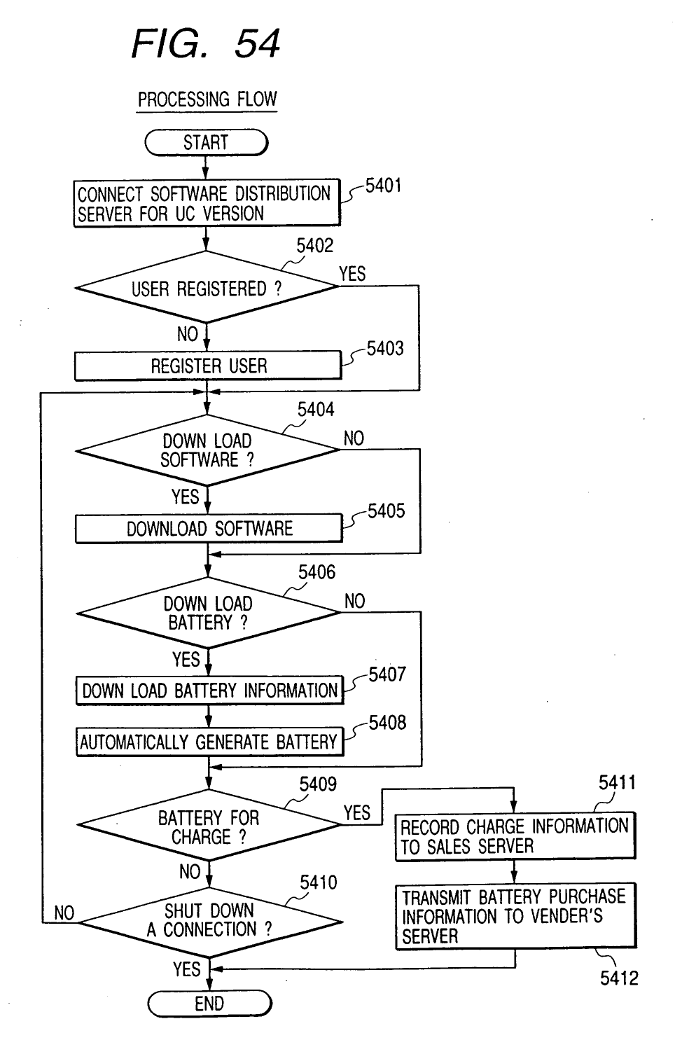

Further explanation is made with reference to FIG. 54. Such a control flow is control effected on the user machine PC (corresponding to the terminal) and the host machine HM (corresponding to the server), and program according to the control flow is stored in a memory, and the program is carried out in a processing part, thereby effecting the control. The following steps are carried out by the processing part.

In a step 5401, a connection to a software (controlled by the battery) distribution server is effected. Then, it is checked whether the user is registered or not. If No, user registration is demanded. Then, in a step 5404, instruction whether down load of the software is effected or not is waiting. If there is instruction, in a step 5405, the down load of the software is effected. Then, instruction whether down load of the battery is effected or not is waiting. If there is instruction, in a step 5407, the down load of the battery information is effected. After the down load, the battery is generated.

Then, in a step 5409, the battery for charge is checked. If No, it is checked whether the connection is shut down or not. If No, the program is returned to the step 5404, where the down load is continued. In a step 5410, if the connection is shut down, the processing is finished. In a step 5409, if Yes, in a step 5411, the charge information is recorded in the sales server, and the battery purchase information is transmitted to the server of the vender, and the processing is finished.

According to the present invention, since the information for charging the battery is always subjected to the communication via the program without sending as the file, duplication of file copy with simple working is made difficult.

Among the supplied batteries, since the batteries can be divided into batteries already used by the user and the others, user's trouble in operation can be avoided.

Since the confirmation information upon charging of the battery is recorded in the log of the host machine, means for ensuring that the charging is effected correctly can be presented to the user machine.

1-13. (canceled)

14. A software battery information management apparatus connected to a client terminal via a network, comprising:
first receiving means for receiving, from the client terminal, personal information of a user of the client terminal and type information on a type of software battery;
transmitting means for transmitting, to the client terminal, battery origin data, a user ID and a battery usage management program based on the received personal information and type information;
second receiving means for receiving, from the client terminal, use history for each software application checked by executing the usage management program at the client terminal;
charge calculating means for calculating a charge for use of each of the checked software applications based on the received use history; and
notifying means for notifying the client terminal of the calculated charge for use of each of the software applications checked by the usage management program.

15. A client terminal connected to a software battery information management apparatus via a network, comprising:
first transmitting means for transmitting, to the software battery information management apparatus, personal information of a user of said client terminal and type information on a type of a software battery;
receiving means for receiving, from the software battery information management apparatus, battery origin data, a user ID and a battery usage management program;
recording means for recording, in accordance with use of a software application, usage of a software battery for each software application checked by executing the battery usage management program at the client terminal, and calculating a remaining amount of the software battery; and
second transmitting means for transmitting, to the software battery information management apparatus, a use history for each software application.

16. A client terminal according to claim 15, further comprising:
generating means for generating the software battery;
notifying means for notifying the software battery information management apparatus that the software battery is generated; and
attribute changing means for changing an attribute of the software application in a case that a response to the notification is received from the software battery information management apparatus.

17. A method of managing software battery information for a client terminal connected to a network, said method comprising:
a first receiving step of receiving, from the client terminal, personal information of a user of the client terminal and type information on a type of software battery;
a transmitting step of transmitting, to the client terminal, battery origin data, a user ID and a battery usage management program based on the received personal information and type information;
a second receiving step of receiving, from the client terminal, use history for each software application checked by executing the battery usage management program at the client terminal;
a charge calculating step of calculating a charge for use of each of the checked software applications based on the received use history; and
a notifying step of notifying the client terminal of the calculated charge for use of each of the software applications checked by the battery usage management program.

18. A method of managing software battery information at a client terminal connected to a software battery information management apparatus via a network, said method comprising:
a first transmitting step of transmitting, to the software battery information management apparatus, personal information of a user of the client terminal and type information on a type of a software battery;
a receiving step of receiving, from the software battery information management apparatus, battery origin data, a user ID and a battery usage management program;
a recording step of recording, in accordance with use of an software application, usage of a software battery for each software application checked by executing the battery usage management program at the client terminal, and calculating a remaining amount of the software battery for each of the software applications; and
a second transmitting step of transmitting, to the software battery information management apparatus, a use history for each software application.

19. A computer-readable medium storing program code for managing software battery information for a client terminal connected to a network, said program comprising:
code of a first receiving step of receiving, from the client terminal, personal information of a user of the client terminal and type information on a type of software battery;
code of a transmitting step of transmitting, to the client terminal, battery origin data, a user ID and a battery usage management program based on the received personal information and type information;
code of a second receiving step of receiving, from the client terminal, use history for each software application checked by executing the usage management program at the client terminal;
code of a charge calculating step of calculating a charge for use of each of the checked software applications based on the received use history; and
code of a notifying step of notifying the client terminal of the calculated charge for use of each of the software applications checked by the usage management program.

20. A computer-readable medium storing program code for managing software battery information at a client terminal connected to a software battery information management apparatus via a network, said program code comprising:
code of a first transmitting step of transmitting, to the software battery information management apparatus, personal information of a user of the client terminal and type information on a type of a software battery;
code of a receiving step of receiving, from the software battery information management apparatus, battery origin data, a user ID and a battery usage management program;
code of a recording step of recording, in accordance with use of an software application, usage of a software battery for each software application checked by executing the battery usage management program at the client terminal, and calculating a remaining amount of the software battery for each of the software applications; and
code of a second transmitting step of transmitting, to the software battery information management apparatus, a use history for each of the software applications.
